(19) United States
(12) Patent Application Publication
(10) Pub. No.: US 2022/0134968 A1
(43) Pub. Date: May 5, 2022

(54) Polyamide Nonwovens in Sound Absorbing Multi-Layer Composites

(71) Applicant: Ascend Performance Materials Operations LLC, Houston, TX (US)

(72) Inventors: Albert Ortega, Houston, TX (US); Wai-Shing Yung, Houston, TX (US); Joseph L. Menner, Houston, TX (US)

(73) Assignee: Ascend Performance Materials Operations LLC, Houston, TX (US)

(21) Appl. No.: 17/515,182

(22) Filed: Oct. 29, 2021

Related U.S. Application Data
(60) Provisional application No. 63/107,885, filed on Oct. 30, 2020.

(51) Int. Cl. B60R 13/08; B32B 5/02; B32B 15/14; G10K 11/168

(52) U.S. Cl. CPC B60R 13/0815; B32B 5/022; B32B 15/14; G10K 11/168; B32B 2605/00; B32B 2307/732; B32B 2262/0261; B32B 2307/72; B32B 2307/102

(57) ABSTRACT

A sound absorbing multi-layer composite for a vehicle that reduces sounds along an acoustic path is configured with a non-foam polymeric layer and a face layer for dissipating sound energy. Also, the face layer may be made of a nonwoven polymer comprising at least 60% of a polyamide containing an aliphatic diamine having 6 or more carbon atoms and an aliphatic diacid having 6 or more carbon atoms. The weighted overall average fiber diameter of the composite is from 2 microns to 25 microns.

### CROSS REFERENCE TO RELATED APPLICATIONS

This application claims priority to U.S. Provisional Application No. 63/107,885, filed Oct. 30, 2020, which is incorporated herein by reference.

### TECHNICAL FIELD

The present disclosure relates to polyamide nonwovens that may be useful for acoustics applications. In particular, the present disclosure related to sound absorbing multi-layer composite comprising a non-foam polymeric layer and a face layer for dissipating sound energy with the weighted overall average fiber diameter of the composite being from 2 microns to 25 microns.

### BACKGROUND

Sound absorption is desirable in numerous applications, including in the transportation and building industries. In transportation, the interior of a vehicle such as an automobile, boat, ship, aircraft, and other means of transportation is desirably insulated from noise originated from the windows, tires, under the vehicle, engine, motor noise, and other environmental sources. This noise may have frequencies ranging from 500 Hz to 7000 Hz and detracted from the quietness inside the vehicle.

Similarly, in the building industry, sound absorption is desirable not only from exterior sounds but from sounds in adjacent rooms and floors of the building. Building industry materials include ceilings (including ceiling tiles), flooring, doors, walls, and roofing. Additional industries that benefit from sound absorption include the appliance industry, including HVAC units, dishwashers and washing machines, the apparel industry, the entertainment industry, and the business industry. For example, noise-cancelling headphones, computers, and gaming systems desirably have sound absorption features. Further, composite materials may desirably have overall sound absorption features or may have such features between or among the layers or combinations of materials.

In selecting a material for absorbing the unwanted sound other considerations such as costs, weight, thickness, ease of installation, or thermal protection are also important. One solution to sound absorption has been to use bulky materials or to add numerous layers of material. Such solutions are problematic though, because they add to the size and weight of the final product/structure.

Various materials have been used for such acoustic applications, including acoustic blankets, insulation, and nonwoven structures. US Pub. No. 2013/0115837 discloses a nanofiber nonwoven comprising a plurality of roped fiber bundles having a length axis. The roped fiber bundles comprise a plurality of nanofibers having a median diameter of less than one micrometer, where at least 50% by number of the nanofibers are oriented within 45 degrees of the length axis of the roped fiber bundles. The nanofibers within the same roped fiber bundle are entangled together. The roped fiber bundles are randomly oriented within the nanofiber nonwoven and are entangled with other roped fiber bundles within the nanofiber nonwoven. The nanofibers comprise a thermoplastic polymer, such as polyester, nylon, polyphenylene sulfide, polybutylene terephthalate, polyethylene, and co-polymers thereof. The nanofibers may be prepared by melt-film fibrillation.

U.S. Pat. No. 8,496,088 discloses an acoustic composite containing at least a first acoustically coupled non-woven composite and a second acoustically coupled non-woven composite, each acoustically coupled non-woven composite containing a non-woven layer and a facing layer. The non-woven layer contains a plurality of binder fibers and a plurality of bulking fibers and has a binder zone and a bulking zone. The facing layer of the second acoustically coupled non-woven composite is adjacent the second surface of the non-woven layer of the first acoustically coupled non-woven composite.

U.S. Pat. No. 7,918,313 discloses an improved acoustically and thermally insulating composite material suitable for use in structures such as buildings, appliances, and the interior passenger compartments and exterior components of automotive vehicles, comprising at least one airlaid fibrous layer of controlled density and composition and incorporating suitable binding agents and additives as needed to meet expectations for noise abatement, fire, and mildew resistance. Separately, an airlaid structure which provides a reduced, controlled airflow there through useful for acoustic insulation is provided, and which includes a woven or nonwoven scrim.

U.S. Pat. No. 7,757,811 discloses multilayer articles having acoustical absorbance properties. As disclosed by this patent, the multilayer article comprises a support layer; and a sub-micron fiber layer on the support layer, said sub-micron fiber layer comprising polymeric fibers having a median fiber diameter of less than 1 micron (μm), wherein said polymeric fibers comprise at least 75 weight percent of a polymer selected from polyolefin, polypropylene, polyethylene, polyester, polyethylene terephthalate, polybutylene terephthalate, polyamide, polyurethane, polybutene, polylactic acid, polyphenylene sulfide, polysulfone, liquid crystalline polymer, polyethylene-co-vinylacetate, polyacrylonitrile, cyclic polyolefin, or a combination thereof.

For example, WO 2015/153477 A1 relates to a fiber construct suitable for use as a fill material for insulation or padding, comprising: a primary fiber structure comprising a predetermined length of fiber; a secondary fiber structure, the secondary fiber structure comprising a plurality of relatively short loops spaced along a length of the primary fiber. Among the techniques enumerated for forming the fiber structures include electrospinning, melt-blowing, melt-spinning and centrifugal-spinning. The products are reported to mimic goose-down, with fill power in the range of 550 to 900.

Despite the variety of techniques and materials proposed, conventional acoustic media have much to be desired in terms of manufacturing costs, processability, and product properties, including weight and bulk.

### SUMMARY

In one aspect there is provided a sound absorbing multi-layer composite for a vehicle that reduces sounds along an acoustic path. In one embodiment, the sound absorbing multi-layer composite may comprise a non-foam polymeric layer having a thickness of at least 1 mm, and a face layer for dissipating sound energy and made of a nonwoven polymer comprising at least 60% of a polyamide containing an aliphatic diamine having 6 or more carbon atoms and an aliphatic diacid having 6 or more carbon atoms, and having at least one surface that is positioned towards the interior of the vehicle. In one embodiment, the composite may be configured to be positioned in the acoustic path so that the sound is at least partially transmitted through the non-foam polymeric layer and at least partially absorbed by the face layer. In one embodiment, the weighted overall average fiber diameter of the composite is from 2 microns to 25 microns. In one embodiment, the face layer comprises at least one low reflectivity metal, such as copper or zinc. There also may be a yarn for stitching the nonfoam polymeric layer to the face layer using a needle punch method. In some embodiments, the composite has an air permeability of less than 200 cfm/ft². In some embodiments, the face layer has a density of less than 0.2 g/cm³. The non-foam polymeric layer may be a non-woven fabric, a woven fabric, a knitted fabric, a film, a paper layer, an adhesive-backed layer, a spun-bonded fabric, a meltblown fabric, or a carded web of staple length fibers. In one embodiment, the face layer may comprise a plurality of nonwoven layers, having at least one nonwoven layer comprising at least 60% of a polyamide containing an aliphatic diamine having 6 or more carbon atoms and an aliphatic diacid having 6 or more carbon atoms. In one embodiment, the face layer comprises a first layer and second layer, where at least one surface of either layer is positioned towards the interior of the vehicle. In one embodiment, the first layer may comprise either a spun bond or melt blown nonwoven polymer comprising at least 60% of a polyamide containing an aliphatic diamine having 6 or more carbon atoms and an aliphatic diacid having 6 or more carbon atoms. In one embodiment, the nonwoven of the first layer may have an average fiber diameter from 200 to 900 nm. In one embodiment, the nonwoven of the first layer has an average fiber diameter that is greater than 1 micron, e.g. from 1 to 25 microns. In one embodiment, the second layer may comprise either a spun bond or melt blown nonwoven polymer comprising at least 60% of a polyamide containing an aliphatic diamine having 6 or more carbon atoms and an aliphatic diacid having 6 or more carbon atoms. In one embodiment, the nonwoven of the second layer may have an average fiber diameter from 200 to 900 nm. In one embodiment, the nonwoven of the second layer has an average fiber diameter that is greater than 1 micron, e.g. from 1 to 25 microns.

In another aspect there is provided a sound absorbing multi-layer composite for a vehicle that reduces sounds along an acoustic path, wherein the composite comprises a non-foam polymeric layer having a thickness of at least 1 mm, and a face layer for dissipating sound energy, wherein the face layer comprises a first and second layer, the first layer being made of a nonwoven polymer comprising at least 60% of a polyamide containing an aliphatic diamine having 6 or more carbon atoms and an aliphatic diacid having 6 or more carbon atoms, having an average fiber diameter that is greater than 1 micron and wherein at least one surface of the second layer is positioned towards the interior of the vehicle, wherein the composite is configured to be positioned in the acoustic path so that the sound is at least partially transmitted through the non-foam polymeric layer and at least partially absorbed by the face layer, wherein the weighted overall average fiber diameter of the composite is from 2 microns to 25 microns. In some embodiments, the second layer may be made of a nonwoven polymer comprising at least 60% of a polyamide containing an aliphatic diamine having 6 or more carbon atoms and an aliphatic diacid having 6 or more carbon atoms, having an average fiber diameter from 200 to 900 nm.

In another aspect there is provided a sound absorbing multi-layer composite for a vehicle that reduces sounds along an acoustic path comprising a non-foam polymeric layer having a thickness of at least 1 mm, and a face layer for dissipating sound energy, wherein the face layer comprises a first and second layer, the first layer being made of a spunbond nonwoven polymer comprising at least 60% of a polyamide containing an aliphatic diamine having 6 or more carbon atoms and an aliphatic diacid having 6 or more carbon atoms, having an average fiber diameter that is greater than 1 micron and wherein at least one surface of the second layer is positioned towards the interior of the vehicle, wherein the composite is configured to be positioned in the acoustic path so that the sound is at least partially transmitted through the non-foam polymeric layer and at least partially absorbed by the face layer, wherein the weighted overall average fiber diameter of the composite is from 2 microns to 25 microns. In one embodiment, the second layer may be made of a nonwoven polymer comprising at least 60% of a polyamide containing an aliphatic diamine having 6 or more carbon atoms and an aliphatic diacid having 6 or more carbon atoms, having an average fiber diameter from 200 to 900 nm.

In another aspect there is provided a sound absorbing multi-layer composite for a vehicle that reduces sounds along an acoustic path comprising a non-foam polymeric layer having a thickness of at least 1 mm, and a face layer for dissipating sound energy, wherein the face layer comprises a first and second layer, the first layer being made of a melt blown nonwoven polymer comprising at least 60% of a polyamide containing an aliphatic diamine having 6 or more carbon atoms and an aliphatic diacid having 6 or more carbon atoms, having an average fiber diameter that is greater than 1 micron and wherein at least one surface of the second layer is positioned towards the interior of the vehicle, wherein the composite is configured to be positioned in the acoustic path so that the sound is at least partially transmitted through the non-foam polymeric layer and at least partially absorbed by the face layer, wherein the weighted overall average fiber diameter of the composite is from 2 microns to 25 microns. In one embodiment, the second layer may be made of a spunbond nonwoven polymer comprising at least 60% of a polyamide containing an aliphatic diamine having 6 or more carbon atoms and an aliphatic diacid having 6 or more carbon atoms.

In another aspect there is provided a component for a vehicle comprising a non-foam polymeric layer having a thickness of at least 1 mm, and a face layer for dissipating sound energy and made of a nonwoven polymer comprising at least 60% of a polyamide containing an aliphatic diamine having 6 or more carbon atoms and an aliphatic diacid having 6 or more carbon atoms, and having at least one surface that is positioned towards the interior of the vehicle, wherein the weighted overall average fiber diameter of the composite is from 2 microns to 25 microns, and wherein the component comprises a headliner, trim, panel, or board. In one embodiment, the composite may be configured to be positioned in the acoustic path so that the sound is at least partially transmitted through the non-foam polymeric layer and at least partially absorbed by the face layer.

### BRIEF DESCRIPTION OF DRAWINGS

The disclosure is described in detail below with reference to the drawings wherein like numerals designate similar parts and wherein:

FIG. 1 is a graph of sound absorption coefficiencies at low frequencies for Examples 1-6 compared with a control.

FIG. 2 is a graph of sound absorption coefficiencies at high frequencies for Examples 1-6 compared with a control.

FIG. 3 is a graph of showing air permeability versus sound absorption coefficiencies for Examples 1-6.

FIG. 4 and FIG. 5 are separate schematic diagrams of a 2-phase propellant-gas spinning system useful in connection with the present disclosure.

### DETAILED DESCRIPTION

### Overview

The present disclosure is directed, in part, to acoustic media comprising a sound absorbing multi-layer composite. Advantageously the sound absorbing multi-layer composite may be positioned in an acoustic path to at least partially absorb sounds and thus provide a quieter environment. The acoustic path refers the path sound travels from the original source to the receiver, which for purposes of illustration may be a passenger in the interior of the vehicle. In one embodiment, there is provided a sound absorbing multi-layer composite comprising a non-foam polymeric layer and a face layer for dissipating sound energy. The face layer preferably has at least one surface that is positioned towards the interior of the vehicle. Positioned towards means that the surface is facing the interior of the vehicle, or at least is more proximal to the interior than the non-foam polymeric layer. In some embodiments at least a portion of the surface may be exposed to the interior of the vehicle. The composite may be positioned in the acoustic path so that the sound is at least partially transmitted through the non-foam polymeric layer and absorbed by the face layer. In one embodiment, the face layer may comprise several nonwoven layers.

In one embodiment, the sound absorbing multi-layer composite is particularly suitable for attenuating sound for at least a portion of a vehicle, preferably the interior of the vehicle. For purposes of this disclosure vehicle includes any mode of transportation that has an interior for one or more passengers. This may include cars, trucks, buses, trains, trolleys, airplanes, helicopters, space vehicles, boats, submarines, etc. In one application, the composite may be used for combustion engine vehicles or electric motor vehicles. In one embodiment, the sound absorbing multi-layer composite is placed on a surface of a vehicle to attenuate sound in the interior of the vehicle. The source of the sound may originate from outside the vehicle interior where the passengers are located. Using the sound absorbing multi-layer composite the sounds in the frequencies from 300 Hz to 5000 Hz, e.g., from 500 Hz to 5000 Hz, from 500 to 3000 Hz, from 500 Hz to 2500 Hz or from 500 Hz to 2000 Hz, may be reduced. Higher frequencies may also be attenuated by the composites described herein, in particular sound in the frequencies of greater than 5000 Hz, e.g., greater than 6500 Hz, or greater than 7000 Hz. As stated above, the face layer preferably has at least one surface that is positioned towards to the interior of the vehicle which allows the sound absorbing multi-layer composite to be used as headliner, dashboard panel, door trim, engine cover, wheelhouse liner, floor, body cavity filler, trunk trim, or seating system to provide a quieter interior while attenuating unwanted noise experienced by the passengers such as external noises.

As a result, the sound absorbing multi-layer composite may be used in several other applications to achieve a desired noise reduction.

### Definitions and Test Methods

Terminology used herein is given its ordinary meaning consistent with the definitions set forth below.

Spinning, as used herein, refers to the steps of melting a polyamide composition and forming the polyamide composition into fibers. Examples of spinning include centrifugal spinning, melt blowing, spinning through a spinneret (e.g., a spinneret without a charge) or die, and “island-in-the sea” geometry.

Percentages and parts per million (ppm) refer to weight percent or parts per million by weight based on the weight of the respective composition unless otherwise indicated.

Some typical definitions and test methods are further recited in US Pub. Nos. 2015/0107457 and 2015/0111019, which are incorporated herein by reference. The term “nonwoven” for example, refers to a web of a multitude of essentially randomly oriented fibers where no overall repeating structure can be discerned by the naked eye in the arrangement of fibers. The fibers can be bonded to each other and/or entangled to impart strength and integrity to the web. In some cases the fibers are not bonded to one another and may or may not be entangled. The fibers can be staple fibers or continuous fibers, and can comprise a single material or a multitude of materials, either as a combination of different fibers or as a combination of similar fibers each comprising of different materials. The nonwoven is constructed predominantly of nanofibers and/or microfibers. “Predominantly” means that greater than 50% of the fibers in the web are nanofibers and/or microfibers. The term “nanofiber” refers to fibers having an average diameter less than 1000 nm (1 micron). The term “microfiber” refers to fibers having an average diameter from 1 micron up to 25 microns. In the case of nonround cross-sectional fibers, the term “diameter” as used herein refers to the greatest cross-sectional dimension.

To the extent not indicated otherwise, test methods for determining average fiber diameters, are as indicated in Hassan et al., J 20 Membrane Sci., 427, 336-344, 2013, unless otherwise specified.

Basis Weight may be determined by ASTM D-3776 and reported in gram per square meter (GSM or g/m²).

“Consisting essentially of” refers to the recited components and excludes other ingredients which would substantially change the basic and novel characteristics of the composition or article. Unless otherwise indicated or readily apparent, a composition or article consists essentially of the recited or listed components when the composition or article includes 90% or more by weight of the recited or listed components. That is, the terminology excludes more than 10% unrecited components.

In some embodiments, any or some of the components disclosed herein may be considered optional. In some cases, the disclosed compositions may expressly exclude any or some of the aforementioned additives in this description, e.g., via claim language. For example claim language may be modified to recite that the disclosed compositions, materials processes, etc., do not utilize or comprise one or more of the aforementioned additives, e.g., the disclosed materials do not comprise a flame retardant or a delusterant. As another example, the claim language may be modified to recite that the disclosed materials do not comprise aromatic polyamide components.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

Air permeability is measured using an Air Permeability Tester, available from Precision Instrument Company, Hagerstown, Md. Air permeability is defined as the flow rate of air at 23±1° C. through a sheet of material under a specified pressure head. It is usually expressed as cubic feet per minute per square foot at 0.50 in. (12.7 mm) water pressure, in cm³ per second per square cm or in units of elapsed time for a given volume per unit area of sheet. The instrument referred to above is capable of measuring permeability from 0 to approximately 5000 cubic feet per minute per square foot of test area. For purposes of comparing permeability, it is convenient to express values normalized to 5 GSM basis weight. This is done by measuring Air Permeability Value and basis weight of a sample (@ 0.5″ H2O typically), then multiplying the actual Air Permeability Value by the ratio of actual basis weight in GSM to 5. For example, if a sample of 15 GSM basis weight has a Value of 10 CFM/ft², its Normalized 5 GSM Air Permeability Value is 30 CFM/ft².

### Non-Foam Polymeric Layer

In some aspects, the sound absorbing multi-layer composite may further comprise a non-foam polymeric layer that is air permeable. For purposes of the present disclosure the sound attenuating properties of the non-foam polymeric layer are generally inadequate alone to achieve the superior noise reduction. This may allow lower cost materials to be used as the non-foam polymeric layer. When combined with the face layer as described herein, the composite demonstrates superior noise reduction properties. In the acoustic path, the non-foam polymeric layer generally allows the sound to be at least partially transmitted through.

In one embodiment, the non-foam polymeric layer provides strength to support the face layer and prevents against tearing or damage. Suitable support layers include, but are not limited to, a non-woven fabric, a woven fabric, a knitted fabric, a film, a paper layer, an adhesive-backed layer, a foil, a mesh, an elastic fabric (i.e., any of the above-described woven, knitted or non-woven fabrics having elastic properties), an apertured web, an adhesive-backed layer, or any combination thereof. In one embodiment a foam layer is preferably avoided as layer in the sound absorbing multi-layer composite due to the relative bulk and sound properties.

In one exemplary embodiment, the non-foam polymeric layer comprises a non-woven fabric. Suitable non-woven fabrics include, but are not limited to, a spun-bonded fabric, a melt-blown fabric, a carded web of staple length fibers (i.e., fibers having a fiber length of less than about 100 mm), a needle-punched fabric, a split film web, a hydro-entangled web, an airlaid staple fiber web, or a combination thereof. In one embodiment, the material of the non-foam polymeric layer may be flexible and/or compressible to allow installation in vehicles. In one embodiment, the non-foam polymeric layer comprises lofty nonwoven webs of flexible thermoplastic fibers. The non-foam polymeric layer may be made of thermoplastic fibers comprising a polyolefin, polyester, polyurethane, polylactic acid, polyphenylene sulfide, polysulfone, liquid crystalline polymer, polyethylene-co-vinylacetate, polyacrylonitrile, or combinations thereof. Particularly preferred polyolefins include polyethylene, polypropylene, polybutene, as well as cyclic olefins. In addition, particularly preferred polyesters include polyethylene terephthalate and polybutylene terephthalate. In some embodiments, there may be multiple layers of the non-foam polymeric layer.

The non-foam polymeric layer may have a basis weight and thickness depending upon the particular end use of the sound absorbing multi-layer composite. In some embodiments of the present disclosure, it is desirable for the overall basis weight and/or thickness of the multilayer article to be kept at a minimum level. In other embodiments, an overall minimum basis weight and/or thickness may be required for a given application. Non-foam polymeric layer may be compressed. In exemplary embodiments, the non-foam polymeric layer may have a basis weight from about 1 gram per square meter (gsm) to about 300 gsm. Typically, the non-foam polymeric layer has a basis weight of less than about 300 gsm, e.g., less than about 250 gsm, less than about 200 gsm, less than about 150 gsm, less than about 75 gsm or less than about 50 gsm. In some embodiments, the non-foam polymeric layer has a basis weight from about 150 gsm to about 250 gsm. In some embodiments, the non-foam polymeric layer has a basis weight from about 5.0 gsm to about 75 gsm. In other embodiments, the non-foam polymeric layer has a basis weight from about 10 gsm to about 50 gsm.

As with the basis weight, the non-foam polymeric layer may have a thickness, which varies depending upon the particular end use of the multilayer article. To avoid excessive weight and/or bulk, the non-foam polymeric layer has a thickness of less than 150 millimeters (mm), e.g., from less than 125 mm, less than 100 mm, less than 75 mm, less than 50 mm, less than 40 mm, less than 30 mm, less than 25 mm, or less than 15 mm. In addition to providing sufficient strength, the non-foam polymeric layer has a thickness of greater than 1 mm, e.g., greater than 2 mm, greater than 5 mm, or greater than 10 mm. In some embodiments, the support layer has a thickness from about 1.0 mm to about 35 mm, e.g., from 10 mm to 35 mm. In other embodiments, the support layer has a thickness from about 2.0 mm to about 25 mm, e.g., from 10 mm to 25 mm.

In one embodiment the non-foam polymeric layer is air permeable. Preferably the air permeability of the non-foam polymeric layer may be greater than the air permeability of the face layer. Accordingly, the non-foam polymeric layer may have an Air Permeability Value that is at least 250 cubic feet per minute per square foot (cfm/ft²), e.g., at least 275 cfm/ft², at least 300 cfm/ft², at least 320 cfm/ft², at least 330 cfm/ft², at least 350 cfm/ft², at least 400 cfm/ft², at least 450 cfm/ft², or at least 500 cfm/ft². Generally, the upper range for the Air Permeability Value of the non-foam polymeric layer may be less than 700 cfm/ft², e.g., less than 600 cfm/ft², less than 550 cfm/ft² or less than 500 cfm/ft². In terms of suitable ranges, the non-foam polymeric layer may have an Air Permeability Value from 250 to 700 cfm/ft², e.g., from 250 to 650 cfm/ft², from 250 to 625 cfm/ft², from 260 to 625 cfm/ft², from 260 to 600 cfm/ft², or from 300 to 600 cfm/ft².

### Face Layer

In one embodiment, the sound absorbing multi-layer composite comprises a face layer for dissipating sound energy. The composition and/or structure, such as the fiber diameter, of the face layer may be such to have a desirable sound dampening effect. This allows the composite to be positioned in the acoustic path so that the sound is at least partially transmitted through the non-foam polymeric layer and absorbed by the face layer. In addition, at least one surface of the face layer is positioned towards the interior of the vehicle, and may be exposed to the interior of the vehicle. In one embodiment, the nonwoven fibers may have an average pore diameter that is smaller than the wavelength of sounds desired to be dampened by the nonwoven. The face layer may comprise a plurality of layers, and each layer may comprise a nonwoven polymer comprising at least 60% of a polyamide containing an aliphatic diamine having 6 or more carbon atoms and an aliphatic diacid having 6 or more carbon atoms. In one embodiment, the face layer comprises a plurality of layers, and in particular at least a first layer and a second layer. To provide effective sound attenuation either the first or second layer of the face layer may comprise a melt blown nonwoven polymer or spun bond nonwoven polymer.

In one embodiment, the face layer comprises a nonwoven polymer comprising at least 60% of a polyamide containing an aliphatic diamine having 6 or more carbon atoms and an aliphatic diacid having 6 or more carbon atoms. More preferably, the face layer comprises a nonwoven polymer that comprises at least 75% of a polyamide containing an aliphatic diamine having 6 or more carbon atoms and an aliphatic diacid having 6 or more carbon atoms, or more preferably at least 80% or at least 85%.

There are numerous advantages of using polyamides, specifically nylons, in commercial applications. Polyamides are generally chemical and temperature resistant, resulting in superior performance to other polymers. Polyamides are also known to have improved strength, elongation, and abrasion resistance as compared to other polymers. Polyamides are also very versatile, allowing for their use in a variety of applications. In particular, the face layer comprising the nonwoven polyamide may have advantageous flame resistant properties. For vehicle applications the face layer may have a flammability rating acceptable for passenger vehicle, in particular is compliant with FMVSS 302. Coatings are typically used to achieve flame resistant properties. However, the coating may impede or otherwise infer with acoustic performance. In one embodiment, the face layer may be uncoated with a FMVSS 302 pass rating.

The inventors have found that by utilizing a particular precursor polyamide having specific characteristics in a particular (spun or melt) spinning method, nonwoven fibers having synergistic features are formed. In some aspects, nanofibers are incorporated into the nonwoven. Without being bound by theory, it is postulated that the use of a polyamide composition having an RV of 330 or less leads to nanofibers having small diameters, previously unachievable by conventional solvent-free methods.

Such nonwovens formed with polyamide fibers surprisingly and unexpectedly have superior sound dampening characteristics as compared to polyamide fibers formed from other polyamide compositions and/or by other production methods. The polyamide fibers may be incorporated into nonwoven for the face layer in the sound absorbing multi-layer composite and advantageously have reduced weight and/or bulk as compared to conventional acoustic media.

As an additional benefit, the production rate for the polyamide fibers is advantageously improved, for example, on a per meter basis, over methods such as electrospinning and solution spinning to form polyamide fibers. Such improvements may be by at least 5%, e.g., by at least 10%, by at least 15%, by at least 20%, by at least 25%, or by at least 30%.

Also, the inventors have found that the disclosed methods, techniques, and/or precursors, yield fibers, e.g., nanofibers, having reduced oxidative degradation and thermal degradation indices as compared to nonwoven products prepared from other precursors and by other methods. These improvements advantageously result in products with improved durability.

Additionally, the method may be conducted in the absence of solvents, e.g., does not use solvents, such as formic acid and others described herein, which reduces environmental concerns with disposing of the solvents and handling of the solvents during preparation of the solutions. Such solvents are used in solution spinning and the solution spinning method therefore requires additional capital investment to dispose of the solvents. Additional costs may be incurred due to the need for a separate solvent room and a scrubber area. There are also health risks associated with some solvents. Accordingly, the nonwoven may be free of residual solvents, e.g., as are necessarily present in solution spun products. For example, residual solvent from 2.2 to 5 wt. % may be found in solution spun methods, as disclosed by L. M. Guerrini, M. C. Branciforti, T Canova, and R. E. S. Bretas, Materials Research, Vol. 12, No. 2, pp 181-190 (2009).

In some aspects, no adhesives are included in the nonwoven. Such adhesives are often included to adhere electrospun fibers to scrims. Although the nonwoven described herein may be blown onto a scrim, in some aspects, no such adhesives are necessary. In other aspects, adhesives may be used, especially depending on the materials in the nonwoven. For example, polypropylene may not adhere well nylon 6,6. In such a case, an adhesive scrim may be used to combine the materials. Such an adhesive scrim may have additional advantages, including low temperature activation, fast curing, and water resistance. Without being bound by theory, it is believed that use of the adhesive scrim with good water resistance may negate the need for any secondary waterproofing step.

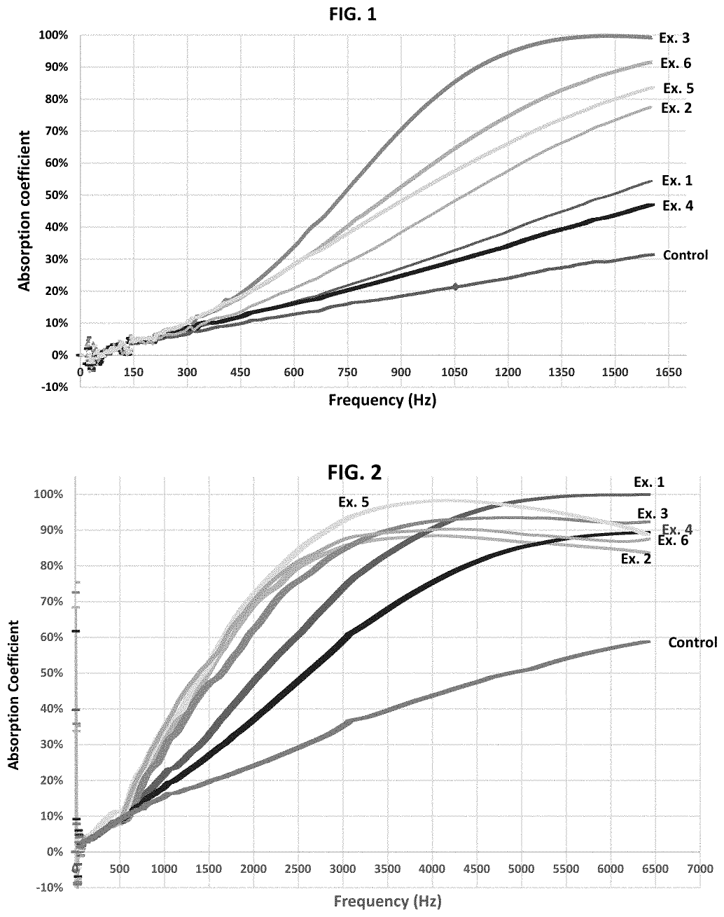

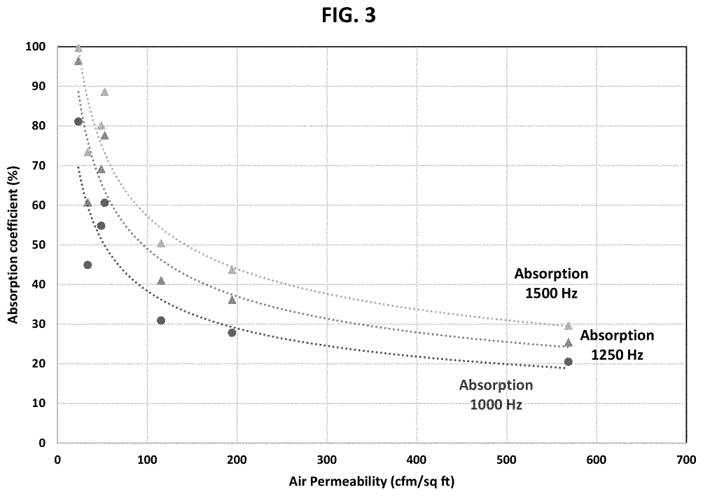

In some embodiments, the nonwoven is produced by: (a) providing a (spinnable) polyamide composition, wherein the polyamide composition has the RV discussed herein; (b) spinning the polyamide composition into a plurality of fibers having an average fiber diameter of less than 25 microns, e.g., by way of a method directed to 2-phase propellant-gas spinning, including extruding the polyamide composition in liquid form with pressurized gas through a fiber-forming channel; and (c) forming the fibers into the nonwoven product. The general method for forming fibers is illustrated in FIGS. 1 and 2. In some aspects, the nonwoven itself may be used as the sound absorbing multi-layer composite. In further aspects disclosed herein, additional layers and/or materials may be included in the sound absorbing multi-layer composite.

Particularly preferred polyamides include nylon 66, as well as copolymers, blends, and alloys of nylon 66 with nylon 6. Other embodiments include nylon derivatives, copolymers, terpolymers, blends and alloys containing or prepared from nylon 66 or nylon 6, copolymers or terpolymers with the repeat units noted above including but not limited to: N6T/66, N612, N6/66, N6I/66, N11, and N12, wherein “N” means Nylon. In some embodiments, the face layer may comprise a class of polyamides referred to as high temperature nylons, as well as blends, derivatives, copolymers or terpolymers containing them, which is referenced in U.S. Pat. No. 10,662,561, the entire contents and disclosure of which is hereby incorporated by reference. Furthermore, another preferred embodiment includes long chain aliphatic polyamide made with long chain diacids, i.e. having more than 10 carbon atoms, as well as blends, derivatives or copolymers containing them. These long chain polyamides include but are not limited to N610, N612, N610/66, or N612/66.

In particular, disclosed herein is an embodiment wherein a method of making a nonwoven wherein the nonwoven is spun-bond or melt-spun by way of melt-blowing through a spinneret into a high velocity gaseous stream. More particularly, in some embodiments, the nonwoven is melt-spun by 2-phase propellant-gas spinning, including extruding the polyamide composition in liquid form with pressurized gas through a fiber-forming channel. The nonwoven is then incorporated into a sound absorbing multi-layer composite.

As used herein, polyamide composition and like terminology refers to compositions containing polyamides including copolymers, terpolymers, polymer blends, alloys and derivatives of polyamides. Further, as used herein, a “polyamide” refers to a polymer, having as a component, a polymer with the linkage of an amino group of one molecule and a carboxylic acid group of another molecule. Nylon copolymers embodied herein, can be made by combining various diamine compounds, various diacid compounds and various cyclic lactam structures in a reaction mixture and then forming the nylon with randomly positioned monomeric materials in a polyamide structure. For example, a nylon 66-6,10 material is a nylon manufactured from hexamethylene diamine and a C6 and a C10 blend of diacids. A nylon 6-66-6,10 is a nylon manufactured by copolymerization of epsilon-aminocaproic acid, hexamethylene diamine and a blend of a C6 and a C10 diacid material.

In one embodiment, the face layer may comprise a polyamide comprising an aliphatic diamine acid having 6 or more carbon atoms including hexanediamine, heptanediamine, octanediamine, nonanediamine, decanediamine, undecanediamine, dodecanediamine, tridecanediamine, tetradecanediamine, hexadecanediamine, octadecenediamine, octadecenediamine, eicosanediamine, docosanediamine or mixtures thereof. Preferably, the aliphatic diamine is hexanediamine and at least 90% of the aliphatic diamine having 6 or more carbon atoms is hexanediamine. In some embodiments, the aliphatic diamine is not modified. Further, cycloaliphatic and aromatic diamines may be excluded from the face layer.

In one embodiment, the face layer may comprise a polyamide comprising an aliphatic diacid having 6 or more carbon atoms including adipic acid, heptanedioic acid, octanedioic acid, azelaic acid, sebacic acid, undecanedioic acid, dodecanedioic acid, brassylic acid, tetradecanedioic acid, hexadecanedioic acid, octadecanedioic acid, octadecenedioic acid, eicosanedioic acid, docosanedioic acid or mixtures thereof. Preferably, the aliphatic diacid is adipic acid and at least 90% of the aliphatic diacids having 6 or more carbon atoms is adipic acid. In some embodiments, the aliphatic diacid is not modified. Further, cycloaliphatic and aromatic diacids are excluded from the face layer.

Exemplary polyamides and polyamide compositions are described in Kirk-Othmer, Encyclopedia of Chemical Technology, Vol. 18, pp. 328371 (Wiley 1982), the disclosure of which is incorporated by reference. Particular polymers and copolymers and their preparation are seen in the following patents: U.S. Pat. Nos. 4,760,129; 5,504,185; 5,543,495; 5,698,658; 6,011,134; 6,136,947; 6,169,162; 7,138,482; 7,381,788; and 8,759,475.

The aliphatic diamine having 6 or more carbon atoms and an aliphatic diacid having 6 or more carbon atoms, may have an amine end group (AEG) level that ranges from 50 μeq/gram to 90 μeq/gram. Amine end groups are defined as the quantity of amine ends (—NH₂) present in a polyamide. AEG calculation methods are well known. In some embodiments, the AEG level may range from 50 μeq/gram to 90 μeq/gram, e.g., from 55 μeq/gram to 85 μeq/gram, from 60 μeq/gram to 90 μeq/gram, from 70 μeq/gram to 90 μeq/gram from 74 μeq/gram to 89 μeq/gram, from 76 μeq/gram to 87 μeq/gram, 78 μeq/gram to 85 μeq/gram, from 60 μeq/gram to 80 μeq/gram, from 62 μeq/gram to 78 μeq/gram, from 65 μeq/gram to 75 μeq/gram, or from 67 μeq/gram to 73.

Melt points of nylon fibers described herein, including copolymers and terpolymers, may be between 223° C. and 390° C., e.g., from 223 to 380, or from 225° C. to 350° C. Additionally, the melt point may be greater than that of conventional nylon 66 melt points depending on any additional polymer materials that are added.

In some embodiments, the face layer may comprise another polymer, preferably in an amount that is less than 40% of the total weight of the face layer. Thermoplastic polymers and biodegradable polymers are also suitable for melt blowing or melt spinning into nanofibers of the present disclosure. Suitable polymers that can be used in the nonwovens for the face layer include both addition polymer and condensation polymer materials such as polyolefin, polyacetal, polyamide (as previously discussed), polyester, cellulose ether and ester, polyalkylene sulfide, polyarylene oxide, polysulfone, modified polysulfone polymers and mixtures thereof. Preferred materials that fall within these generic classes include polyamides, polyethylene, polybutylene terephthalate (PBT), polypropylene, poly(vinylchloride), polymethylmethacrylate (and other acrylic resins), polystyrene, and copolymers thereof (including ABA type block copolymers), poly(vinylidene fluoride), poly(vinylidene chloride), polyvinylalcohol in various degrees of hydrolysis (87% to 99.5%) in crosslinked and non-crosslinked forms. Addition polymers tend to be glassy (a Tg greater than room temperature). This is the case for polyvinylchloride and polymethylmethacrylate, polystyrene polymer compositions or alloys or low in crystallinity for polyvinylidene fluoride and polyvinylalcohol materials. As discussed herein, the polymers may be melt spun or melt blown, with a preference for melt spinning or melt blowing by 2-phase propellant-gas spinning, including extruding the polyamide composition in liquid form with pressurized gas through a fiber-forming channel.

In some embodiments, such as that described in U.S. Pat. No. 5,913,993, a small amount of polyethylene polymer can be blended with a polyamide to form a face layer nanofiber nonwoven fabric with desirable characteristics. The addition of polyethylene to nylon enhances specific properties such as softness. The use of polyethylene also lowers cost of production, and eases further downstream processing such as bonding to other fabrics or itself. The improved fabric can be made by adding a small amount of polyethylene to the nylon feed material used in producing a nanofiber melt blown fabric. More specifically, the fabric can be produced by forming a blend of polyethylene and nylon 66, extruding the blend in the form of a plurality of continuous filaments, directing the filaments through a die to melt blow the filaments, depositing the filaments onto a collection surface such that a web is formed.

The polyethylene useful in the method of this embodiment of the subject disclosure preferably may have a melt index between about 5 grams/10 min and about 200 grams/10 min and, e.g., between about 17 grams/10 min and about 150 grams/10 min. The polyethylene should preferably have a density between about 0.85 grams/cc and about 1.1 grams/cc and, e.g., between about 0.93 grams/cc and about 0.95 grams/cc. Most preferably, the melt index of the polyethylene is about 150 and the density is about 0.93.

The polyethylene used in the method of this embodiment of the subject disclosure can be added at a concentration of about 0.05% to about 20%. In a preferred embodiment, the concentration of polyethylene will be between about 0.1% and about 1.2%. Most preferably, the polyethylene will be present at about 0.5%. The concentration of polyethylene in the fabric produced according to the method described will be approximately equal to the percentage of polyethylene added during the manufacturing method. Thus, the percentage of polyethylene in the fabrics of this embodiment of the subject disclosure will typically range from about 0.05% to about 20% and will preferably be about 0.5%. Therefore, the fabric will typically comprise between about 80 and about 99.95 percent by weight of nylon. The filament extrusion step can be carried out between about 250° C. and about 325° C. Preferably, the temperature range is about 280° C. to about 315° C. but may be lower if nylon 6 is used.

The blend or copolymer of polyethylene and nylon can be formed in any suitable manner. Typically, the nylon compound will be nylon 66; however, other polyamides of the nylon family can be used. Also, mixtures of nylons can be used. In one specific example, polyethylene is blended with a mixture of nylon 6 and nylon 66. The polyethylene and nylon polymers are typically supplied in the form of pellets, chips, flakes, and the like. The desired amount of the polyethylene pellets or chips can be blended with the nylon pellets or chips in a suitable mixing device such as a rotary drum tumbler or the like, and the resulting blend can be introduced into the feed hopper of the conventional extruder or the melt blowing line. The blend or copolymer can also be produced by introducing the appropriate mixture into a continuous polymerization spinning system.

Further, differing species of a general polymeric genus can be blended. For example, a high molecular weight styrene material can be blended with a low molecular weight, high impact polystyrene. A Nylon-6 material can be blended with a nylon copolymer such as a Nylon-6; 66; 6,10 copolymer. Further, a polyvinylalcohol having a low degree of hydrolysis such as a 87% hydrolyzed polyvinylalcohol can be blended with a fully or superhydrolyzed polyvinylalcohol having a degree of hydrolysis between 98 and 99.9% and higher. All of these materials in admixture can be crosslinked using appropriate crosslinking mechanisms. Nylons can be crosslinked using crosslinking agents that are reactive with the nitrogen atom in the amide linkage. Polyvinyl alcohol materials can be crosslinked using hydroxyl reactive materials such as monoaldehydes, such as formaldehyde, ureas, melamine-formaldehyde resin and its analogues, boric acids and other inorganic compounds, dialdehydes, diacids, urethanes, epoxies and other known crosslinking agents. Crosslinking technology is a well-known and understood phenomenon in which a crosslinking reagent reacts and forms covalent bonds between polymer chains to substantially improve molecular weight, chemical resistance, overall strength and resistance to mechanical degradation.

One preferred mode is a polyamide comprising a first polymer and a second, but different polymer (differing in polymer type, molecular weight or physical property) that is conditioned or treated at elevated temperature. The polymer blend can be reacted and formed into a single chemical specie or can be physically combined into a blended composition by an annealing method. Annealing implies a physical change, like crystallinity, stress relaxation or orientation. Preferred materials are chemically reacted into a single polymeric specie such that a Differential Scanning Calorimeter (DSC) analysis reveals a single polymeric material to yield improved stability when contacted with high temperature, high humidity and difficult operating conditions. Preferred materials for use in the blended polymeric systems include nylon 6; nylon 66; nylon 6,10; nylon (6-66-6,10) copolymers and other linear generally aliphatic nylon compositions.

A suitable polyamide may include for example, 20% nylon 6, 60% nylon 66 and 20% by weight of a polyester. The polyamide may include combinations of miscible polymers or combinations of immiscible polymers.

In some aspects, the polyamide may include nylon 6. In terms of lower limits, the polyamide may include nylon 6 in an amount of at least 0.1 wt. %, e.g., at least 1 wt. %, at least 5 wt. %, at least 10 wt. %, at least 15 wt. %, or at least 20 wt. %. In terms of upper limits, the polyamide may include nylon 6 in an amount of 40 wt. % or less, 39 wt. % or less, 35 wt. % or less, 30 wt. % or less, 25 wt. % or less, or 20 wt. % or less. In terms of ranges, the polyamide may comprise nylon 6 in an amount from 0.1 to 40 wt. %, e.g., from 1 to 35 wt. %, from 5 to 30 wt. %, from 10 to 30 wt. %, from 15 to 25 wt. %, or from 20 to 25 wt. %.

In some aspects, the polyamide may include nylon 66. In terms of lower limits, the polyamide may include nylon 66 in an amount of at least 60 wt. %, e.g., at least 65 wt. %, at least 70 wt. %, at least 75 wt. %, at least 80 wt. %, or at least 85 wt. %. In terms of upper limits, the polyamide may include nylon 66 in an amount of 99.9 wt. % or less, 99 wt. % or less, 95 wt. % or less, 90 wt. % or less, 85 wt. % or less, or 80 wt. % or less. In terms of ranges, the polyamide may comprise nylon 66 in an amount from 60 to 99.9 wt. %, e.g., from 60 to 99 wt. %, from 65 to 95 wt. %, from 70 to 90 wt. %, from 70 to 85 wt. %, or from 70 to 80 wt. %.

In some aspects, the polyamide may include nylon 6I. In terms of lower limits, the polyamide may include nylon 6I in an amount of at least 0.1 wt. %, e.g., at least 0.5 wt. %, at least 1 wt. %, at least 5 wt. %, at least 7.5 wt. %, or at least 10 wt. %. In terms of upper limits, the polyamide may include nylon 6I in an amount of 40 wt. % or less, e.g., 35 wt. % or less, 30 wt. % or less, 25 wt. % or less, or 20 wt. % or less. In terms of ranges, the polyamide may comprise nylon 6I in an amount from 0.1 to 40 wt. %, e.g., from 0.5 to 40 wt. %, from 1 to 35 wt. %, from 5 to 30 wt. %, from 7.5 to 25 wt. %, or from 10 to 20 wt. %.

In some aspects, the polyamide may include nylon 6T. In terms of lower limits, the polyamide may include nylon 6T in an amount of at least 0.1 wt. %, e.g., at least 1 wt. %, at least 5 wt. %, at least 10 wt. %, at least 15 wt. %, or at least 20 wt. %. In terms of upper limits, the polyamide may include nylon 6T in an amount of 40 wt. % or less, e.g., 35 wt. % or less, 30 wt. % or less, 25 wt. % or less, or 20 wt. % or less. In terms of ranges, the polyamide may comprise nylon 6T in an amount from 0.1 to 40 wt. %, e.g., from 0.5 to 40 wt. %, from 1 to 35 wt. %, from 5 to 30 wt. %, from 7.5 to 25 wt. %, or from 10 to 20 wt. %.

Block copolymers are also useful in the method of this disclosure. With such copolymers the choice of solvent swelling agent is important. The selected solvent is such that both blocks were soluble in the solvent. One example is an ABA (styrene-EP-styrene) or AB (styrene-EP) polymer in methylene chloride solvent. If one component is not soluble in the solvent, it will form a gel. Examples of such block copolymers are Kraton® type of styrene-b-butadiene and styrene-b-hydrogenated butadiene (ethylene propylene), Pebax® type of e-caprolactam-b-ethylene oxide, Sympatex® polyester-b-ethylene oxide and polyurethanes of ethylene oxide and isocyanates.

Addition polymers like polyvinylidene fluoride, syndiotactic polystyrene, copolymer of vinylidene fluoride and hexafluoropropylene, polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, are known to be solution spun with relative ease because they are soluble at low pressures and temperatures. It is envisioned these can be melt spun per the instant disclosure as one method of making nanofibers.

There is a substantial advantage to forming polymeric compositions comprising two or more polymeric materials in polymer admixture, alloy format or in a crosslinked chemically bonded structure. We believe such polymer compositions improve physical properties by changing polymer attributes such as improving polymer chain flexibility or chain mobility, increasing overall molecular weight and providing reinforcement through the formation of networks of polymeric materials.

In some embodiments of this concept, two related polymer materials can be blended for beneficial properties. For example, a high molecular weight polyvinylchloride can be blended with a low molecular weight polyvinylchloride. Similarly, a high molecular weight nylon material can be blended with a low molecular weight nylon material.

Relative viscosity (RV) of polyamides (and resultant products) is generally a ratio of solution or solvent viscosities measured in a capillary viscometer at 25° C. (ASTM D 789) (2015). For present purposes the solvent is formic acid containing 10% by weight water and 90% by weight formic acid. The solution is 8.4% by weight polymer dissolved in the solvent.

The RV (ηᵣ) as used with respect to the disclosed polymers and products is the ratio of the absolute viscosity of the polymer solution to that of the formic acid:

ηᵣ=(ηₚ/η_{f})=(fᵣ×dₚ×tₚ)/η_{f}

where: dₚ=density of formic acid-polymer solution at 25° C.,
tₚ=average efflux time for formic acid-polymer solution,
μ_{f}=absolute viscosity of formic acid, kPa×s(E+6 cP) and
fᵣ=viscometer tube factor, mm²/s (cSt)/s=ηᵣ/t₃.

A typical calculation for a 50 RV specimen:

ηr=(fr×dp×tp)/ηf

where:

fr=viscometer tube factor, typically 0.485675 cSt/s

dp=density of the polymer-formic solution, typically 1.1900 g/ml

tp=average efflux time for polymer-formic solution, typically 135.00 s

ηf=absolute viscosity of formic acid, typically 1.56 cP

giving an RV of ηr=(0.485675 cSt/s×1.1900 g/ml×135.00 s)/1.56 cP=50.0. The term t₃ is the efflux time of the S-3 calibration oil used in the determination of the absolute viscosity of the formic acid as required in ASTM D789 (2015).

In some embodiments, the RV of the (precursor) polyamide has a lower limit of at least 2, e.g., at least 3, at least 4, or at least 5. In terms of upper limits, the polyamide has an RV of at 330 or less, 300 or less, 275 or less, 250 or less, 225 or less, 200 or less, 150 or less, 100 or less, or 60 or less. In terms of ranges, the polyamide may have an RV of 2 to 330, e.g., from 2 to 300, from 2 to 275, from 2 to 250, from 2 to 225, from 2 to 200, 2 to 100, from 2 to 60, from 2 to 50, from 2 to 40, from 10 to 40, or from 15 to 40 and any values in between.

In some embodiments, the RV of the nonwoven has a lower limit of at least 2, e.g., at least 3, at least 4, or at least 5. In terms of upper limits, the nanofiber nonwoven product has an RV of at 330 or less, 300 or less, 275 or less, 250 or less, 225 or less, 200 or less, 150 or less, 100 or less, or 60 or less. In terms of ranges, the nonwoven may have an RV of 2 to 330, e.g., from 2 to 300, from 2 to 275, from 2 to 250, from 2 to 225, from 2 to 200, 2 to 100, from 2 to 60, from 2 to 50, from 2 to 40, from 10 to 40, or from 15 to 40, and any values in between.

The relationship between the RV of the (precursor) polyamide composition and the RV of the nonwoven may vary. In some aspects, the RV of the nonwoven may be lower than the RV of the polyamide composition. Reducing the RV conventionally has not been a desirable practice when spinning nylon 66. The inventors, however, have discovered that, in the production of microfibers and nanofibers, it is an advantage. It has been found that the use of lower RV polyamide nylons, e.g., lower RV nylon 66, in a melt spinning method has surprisingly been found to yield microfiber and nanofiber filaments having unexpectedly small filament diameters.

The method by which the RV is lowered may vary widely. In some cases, method temperature may be raised to lower the RV. In some embodiments, however, the temperature raise may only slightly lower the RV since temperature affects the kinetics of the reaction, but not the reaction equilibrium constant. The inventors have discovered that, beneficially, the RV of the polyamide, e.g., the nylon 66, may be lowered by depolymerizing the polymer with the addition of moisture. Up to 5% moisture, e.g., up to 4%, up to 3%, up to 2%, or up to 1%, may be included before the polyamide begins to hydrolyze. This technique provides a surprising advantage over the conventional method of adding other polymers, e.g., polypropylene, to the polyamide (to reduce RV).

In some aspects, the RV may be raised, e.g., by lowering the temperature and/or by reducing the moisture. Again, temperature has a relatively modest effect on adjusting the RV, as compared to moisture content. The moisture content may be reduced to as low as 1 ppm or greater, e.g., 5 ppm or greater, 10 ppm or greater, 100 ppm or greater, 500 ppm or greater, 1000 ppm or greater, or 2500 ppm or greater. Reduction of moisture content is also advantageous for decreasing TDI and ODI values, discussed further herein. Inclusion of a catalyst may affect the kinetics, but not the actual K value.

In some aspects, the RV of the nonwoven is at least 20% less than the RV of the polyamide prior to spinning, e.g., at least 25% less, at least 30% less, at least 35% less, at least 40% less, at least 45% less, or at least 90% less.

In other aspects, the RV of the nonwoven is at least 5% greater than the RV of the polyamide prior to spinning, e.g., at least 10% greater, at least 15% greater, at least 20% greater, at least 25% greater, at least 30% greater, or at least 35% greater.

In still further aspects, the RV of the polyamide and the RV of the nonwoven may be substantially the same, e.g., within 5% of each other.

An additional embodiment of the present disclosure involves production of an face layer comprising polyamide nanofibers and/or microfibers having an average fiber diameter of less than 25 microns, and having an RV from 2 to 330. In this alternate embodiment, preferable RV ranges include: 2 to 330, e.g., from 2 to 300, from 2 to 275, from 2 to 250, from 2 to 225, from 2 to 200, 2 to 100, from 2 to 60, from 2 to 50, from 2 to 40, from 10 to 40, or from 15 to 40. The nanofibers and/or microfibers are subsequently converted to nonwoven web. As the RV increases beyond about 20 to 30, operating temperature becomes a greater parameter to consider. At an RV above the range of about 20 to 30, the temperature must be carefully controlled so as the polymer melts for processing purposes. Methods or examples of melt techniques are described in U.S. Pat. No. 8,777,599 (incorporated by reference herein), as well as heating and cooling sources which may be used in the apparatuses to independently control the temperature of the fiber producing device. Non limiting examples include resistance heaters, radiant heaters, cold gas or heated gas (air or nitrogen), or conductive, convective, or radiation heat transfer mechanisms.

In the face layer, the nonwoven comprise fibers produced by spunbond and melt blown process. In one embodiment, the fibers disclosed herein are microfibers, e.g., fibers having an average fiber diameter of less than 25 microns, or nanofibers, e.g., fibers having an average fiber diameter of less than 1000 nm (1 micron).

In the case of polyamides having an RV above 2 and less than 330, the average fiber diameter of the nanofibers in the fiber layer of the nonwoven may be less than 1 micron, e.g., less than 950 nanometers, less than 925 nanometers, less than 900 nanometers, less than 800 nanometers, less than 700 nanometers, less than 600 nanometers, or less than 500 nanometers. In terms of lower limits, the average fiber diameter of the nanofibers in the fiber layer of the nonwoven may have an average fiber diameter of at least 100 nanometers, at least 110 nanometers, at least 115 nanometers, at least 120 nanometers, at least 125 nanometers, at least 130 nanometers, or at least 150 nanometers. In terms of ranges, the average fiber diameter of the nanofibers in the fiber layer of the nonwoven may be from 100 to 1000 nanometers, e.g., from 110 to 950 nanometers, from 115 to 925 nanometers, from 120 to 900 nanometers, from 200 to 900 nanometers, from 125 to 800 nanometers, from 125 to 700 nanometers, from 130 to 600 nanometers, or from 150 to 500 nanometers. Such average fiber diameters differentiate the nanofibers formed by the spinning methods disclosed herein from nanofibers formed by electrospinning methods. Electrospinning methods typically have average fiber diameters of less than 100 nanometers, e.g., from 50 up to less than 100 nanometers. Without being bound by theory, it is believed that such small nanofiber diameters may result in reduced strength of the fibers and increased difficulty in handling the nanofibers.

The use of the disclosed method and precursors leads to a specific and beneficial distribution of fiber diameters. For example, in the case of nanofibers, less than 20% of the nanofibers may have a fiber diameter from greater than 700 nanometers, e.g., less than 17.5%, less than 15%, less than 12.5%, or less than 10%. In terms of lower limits, at least 1% of the nanofibers have a fiber diameter of greater than 700 nanometers, e.g., at least 2%, at least 3%, at least 4%, or at least 5%. In terms of ranges, from 1 to 20% of the nanofibers have a fiber diameter of greater than 700 nanometers, e.g., from 2 to 17.5%, from 3 to 15%, from 4 to 12.5%, or from 5 to 10%. Such a distribution differentiates the nanofiber nonwoven products described herein from those formed by electrospinning (which have a smaller average diameter (50-100 nanometers) and a much narrower distribution) and from those formed by non-nanofiber melt spinning (which have a much greater distribution). For example, a non-nanofiber centrifugally spun nonwoven is disclosed in WO 2017/214085 and reports fiber diameters of 2.08 to 4.4 microns but with a very broad distribution reported in FIG. 10A of WO 2017/214085.

In the case of polyamides having an RV above 2 and below 330, the average fiber diameter of the microfibers in the fiber layer of the nonwoven may be less than 25 microns, e.g., less than 24 microns, less than 22 microns, less than 20 microns, less than 15 microns, less than 10 microns, or less than 5 microns. In terms of lower limits, the average fiber diameter of the microfibers in the fiber layer of the nonwoven may have an average fiber diameter of at least 1 micron, at least 2 microns, at least 3 microns, at least 5 microns, at least 7 microns, or at least 10 microns. In terms of ranges, the average fiber diameter of the nanofibers in the fiber layer of the nonwoven may be from 1 to 25 microns, e.g., from 2 to 24 microns, from 3 to 22 microns, from 5 to 20 microns, from 7 to 15 microns, from 2 to 10 microns, or from 1 to 5 microns.

In the case of microfibers, the fiber diameter may also have a desirably narrow distribution depending on the size of the microfiber. For example, less than 20% of the microfibers may have a fiber diameter greater than 2 microns greater than the average fiber diameter, e.g., less than 17.5%, less than 15%, less than 12.5%, or less than 10%. In terms of lower limits, at least 1% of the microfibers have a fiber diameter of greater than 2 microns greater than the average fiber diameter, e.g., at least 2%, at least 3%, at least 4%, or at least 5%. In terms of ranges, from 1 to 20% of the microfibers have a fiber diameter of greater than 2 microns greater than the average fiber diameter, e.g., from 2 to 17.5%, from 3 to 15%, from 4 to 12.5%, or from 5 to 10%. In further examples, the above recited distributions may be within 1.5 microns of the average fiber diameter, e.g., within 1.25 microns, within 1 micron, or within 500 nanometers.

In an embodiment, advantages are envisioned having two related polymers with different RV values (both less than 330 and having an average fiber diameter less than 1 micron) blended for a desired property. For example, the melting point of the polyamide may be increased, the RV adjusted, or other properties adjusted.

In one embodiment, the face layer comprises a nonwoven that may have a basis weight chosen depending upon the end use of the sound absorbing multi-layer composite. In terms of lower limits, the nonwoven may have a basis weight of at least 1 gram per square meter (gsm), e.g., at least 2 gsm, at least 3 gsm, at least 5 gsm, at least 10 gsm, or at least 25 gsm. In terms of upper limits, the nonwoven may have a basis weight of less than 200 gsm, e.g., less than 190 gsm, less than 180 gsm, less than 175 gsm, less than 150 gsm, or less than 125 gsm. In terms of ranges, the nonwoven may have a basis weight from 1 to 200 gsm, e.g., from 2 to 190 gsm, from 3 to 180 gsm, from 5 to 175 gsm, from 10 to 150 gsm, or from 25 to 125 gsm.

In order to control the degree of sound absorption, the basis weight may be selected in combination with the average fiber diameter. For example, for a greater average fiber diameter, e.g., a microfiber, the pore size may be greater and the basis weight may be increased to increase sound dampening relative to a nonwoven having a lesser average fiber diameter. Additionally, depending on the other materials, if any, include in the sound absorbing multi-layer composite, different layers of nonwoven, each having the same or different average fiber diameters and/or basis weights, may be used to control sound dampening.

In one embodiment the face layer comprises a nonwoven having polyamide nanofibers and polyamide microfibers. The nanofibers and microfibers may be arranged as separate layers, i.e. a first and second layer, or may be arranged together as one layer. In some aspects, the face layer may comprise polyamide nonwoven comprising nanofibers as described above. In some aspects, the face layer may comprise polyamide nonwoven comprising nanofibers as described above. In still further aspects, the nonwoven may comprise a combination of polyamide nanofibers and polyamide microfibers. For example, the nonwoven may comprise polyamide nanofibers to polyamide microfibers in a ratio of 1:100 to 100:1, based on weight, e.g., from 1:75 to 75:1, from 1:50 to 50:1, from 1:25 to 25:1, from 1:15 to 15:1, from 1:10 to 10:1, from 1:5 to 5:1, from 1:3 to 3:1, from 1:2 to 2:1 or approximately 1:1. In terms of lower limits for the polyamide nanofibers, the nonwoven may comprise at least 1 wt. % polyamide nanofibers, e.g., at least 3 wt. %, at least 5 wt. %, at least 10 wt. %, at least 25 wt. %, or at least 50 wt. %. In terms of upper limits, the nonwoven may comprise less than 99 wt. % polyamide nanofibers, e.g., less than 95 wt. %, less than 90 wt. %, less than 75 wt. %, or less than 50 wt. %. In terms of ranges, the nonwoven may comprise from 1 to 99 wt. % polyamide nanofibers, e.g., from 3 to 95 wt. %, from 5 to 90 wt. %, from 10 to 75 wt. %, from 25 to 50 wt. %, or from 50 to 75 wt. %. In terms of lower limits for the polyamide microfibers, the nonwoven may comprise at least 1 wt. % polyamide microfibers, e.g., at least 3 wt. %, at least 5 wt. %, at least 10 wt. %, at least 25 wt. %, or at least 50 wt. %. In terms of upper limits, the nonwoven may comprise less than 99 wt. % polyamide microfibers, e.g., less than 95 wt. %, less than 90 wt. %, less than 75 wt. %, or less than 50 wt. %. In terms of ranges, the nonwoven may comprise from 1 to 99 wt. % polyamide microfibers, e.g., from 3 to 95 wt. %, from 5 to 90 wt. %, from 10 to 75 wt. %, from 25 to 50 wt. %, or from 50 to 75 wt. %.

### Additional Components

In some embodiments, the resultant fibers contain small amounts, if any, of solvent. Accordingly, in some aspects, the resultant fibers are free of solvent. It is believed that the use of the melt spinning method advantageously reduces or eliminates the need for solvents. This reduction/elimination leads to beneficial effects such as environmental friendliness and reduced costs. Fibers formed via solution spinning methods, which are entirely different from melt spinning methods described herein, require such solvents. In some embodiments, the nanofibers comprise less than 1 wt. % solvent, less than 5000 ppm, less than 2500 ppm, less than 2000 ppm, less than 1500 ppm, less than 1000 ppm, less than 500 ppm, less than 400 ppm, less than 300 ppm, less than 200 ppm, less than 100 ppm, or less than a detectable amount of solvent. Solvents may vary depending on the components of the polyamide but may include formic acid, sulfuric acid, toluene, benzene, chlorobenzene, xylene/chlorohexanone, decalin, paraffin oil, ortho dichlorobenzene, and other known solvents. In terms of ranges, when small amounts of solvent are included, the resultant nanofibers may have at least 1 ppm, at least 5 ppm, at least 10 ppm, at least 15 ppm, or at least 20 ppm solvent. In some aspects, non-volatile solvents, such as formic acid, may remain in the product and may require an additional extraction step. Such an additional extraction step may add to production costs.

In one embodiment, the face layer comprises a nonwoven having at least one low reflectivity metal, which includes copper, zinc, and/or compounds, oxides, complex salts, or alloys thereof. Suitable copper compounds include copper iodide, copper bromide, copper chloride, copper fluoride, copper oxide, copper stearate, copper ammonium adipate, copper acetate, or copper pyrithione, or combinations thereof. The zinc compound may include zinc oxide, zinc stearate, zinc pyrithione, or zinc ammonium adipate, or combinations thereof. In some embodiments, there may be a combination of low reflectivity metals. In some embodiments, the ionic form of the low reflectivity metal may be present. The low reflectivity metals may be dispersed throughout the nonwoven. In one embodiment, the loading of low reflectivity metals may be in an amount from may be from 5 ppm to 100,000 ppm (10 wt %), e.g., 5 ppm to 20000 ppm, from 5 ppm to 17,500 ppm, from 5 ppm to 17,000 ppm, from 5 ppm to 16,500 ppm, from 5 ppm to 16,000 ppm, from 5 ppm to 15,500 ppm, from 5 ppm to 15,000 ppm, from 5 ppm to 12,500 ppm, from 5 ppm to 10,000 ppm, from 5 ppm to 5000 ppm, from 5 ppm to 4000 ppm, e.g., from 5 ppm to 3000 ppm, from 5 ppm to 2000 ppm, from 5 ppm to 1000 ppm, from 5 ppm to 500 ppm, from 10 ppm to 20,000 ppm, from 10 ppm to 17,500 ppm, from 10 ppm to 17,000 ppm, from 10 ppm to 16,500 ppm, from 10 ppm to 16,000 ppm, from 10 ppm to 15,500 ppm, from 10 ppm to 15,000 ppm, from 10 ppm to 12,500 ppm, from 10 ppm to 10,000 ppm, from 10 ppm to 5000 ppm, from 10 ppm to 4000 ppm, from 10 ppm to 3000 ppm, from 10 ppm to 2000 ppm, from 10 ppm to 1000 ppm, from 10 ppm to 500 ppm, from 50 ppm to 20,000 ppm, from 50 ppm to 17,500 ppm, from 50 ppm to 17,000 ppm, from 50 ppm to 16,500 ppm, from 50 ppm to 16,000 ppm, from 50 ppm to 15,500 ppm, from 50 ppm to 15,000 ppm, from 50 ppm to 12,500 ppm, from 50 ppm to 10,000 ppm, from 50 ppm to 5000 ppm, from 50 ppm to 4000 ppm, from 50 ppm to 3000 ppm, 50 ppm to 500 ppm, from 100 ppm to 20,000 ppm, from 100 ppm to 17,500 ppm, from 100 ppm to 17,000 ppm, from 100 ppm to 16,500 ppm, from 100 ppm to 16,000 ppm, from 100 ppm to 15,500 ppm, from 100 ppm to 15,000 ppm, from 100 ppm to 12,500 ppm, from 100 ppm to 10,000 ppm, from 100 ppm to 5000 ppm, from 100 ppm to 4000 ppm, from 100 ppm to 500 ppm, from 200 ppm to 20,000 ppm, from 200 ppm to 17,500 ppm, from 200 ppm to 17,000 ppm, from 200 ppm to 16,500 ppm, from 200 ppm to 16,000 ppm, from 200 ppm to 15,500 ppm, from 200 ppm to 15,000 ppm, from 200 ppm to 12,500 ppm, from 200 ppm to 10,000 ppm, from 200 ppm to 5000 ppm, from 200 ppm to 4000 ppm, 5000 ppm to 20000 ppm, from 200 ppm to 500 ppm, from 500 ppm to 10000 ppm, from 1000 ppm to 7000 ppm, or from 3000 ppm to 5000 ppm.

In some embodiments, the non-foam polymeric layer may also comprise at least one low reflectivity metal. Preferably the amount of the at least one low reflectivity metal is lower in the non-foam polymeric layer than the face layer.

In some embodiments, the low reflectivity metal may also provide the composite an antimicrobial efficacy that may be useful in some applications.

In some cases, the nonwoven may be made of a polyamide material that optionally includes an additive. Examples of suitable additives include fillers (such as silica, glass, clay, talc), oils (such as finishing oils, e.g., silicone oils), waxes, solvents (including formic acid as described herein), lubricants (e.g., paraffin oils, amide waxes, and stearates), stabilizers (e.g., photostabilizers, UV stabilizers, etc.), plasticizer, tackifier, flow control agent, cure rate retarder, adhesion promoter, adjuvant, impact modifier, expandable microsphere, thermally conductive particle, electrically conductive particles, pigments, dyes, colorants, glass beads or bubbles, antioxidants, optical brighteners, antimicrobial agents, surfactants, fire retardants, and fluoropolymers. In one embodiment, the additives may be present in a total amount of up to 49 wt. % of the nonwoven, e.g., up to 40 wt. %, up to 30 wt. %, up to 20 wt. %, up to 10 wt. %, up to 5 wt. %, up to 3 wt. %, or up to 1 wt. %. In terms of lower limits, the additives may be present in the nonwoven in an amount of at least 0.01 wt. %, e.g., at least 0.05 wt. %, at least 0.1 wt. %, at least 0.25 wt. %, or at least 0.5 wt. %. In terms of ranges, the additives may be present in the nonwoven in an amount from 0.01 to 49 wt. %, e.g., from 0.05 to 40 wt. %, from 0.1 to 30 wt. %, from 0.25 to 20 wt. %, from 0.5 to 10 wt. %, from 0.5 to 5 wt. %, or from 0.5 to 1 wt. %. In some aspects, monomers and/or polymers may be included as additives. For example, nylon 6I and/or nylon 6T may be added as an additive.

Antioxidants suitable for use in conjunction with the nonwoven described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, ubiquinol, gallic acids, melatonin, secondary aromatic amines, benzofuranones, hindered phenols, polyphenols, hindered amines, organophosphorus compounds, thioesters, benzoates, lactones, hydroxylamines, and the like, and any combination thereof. In some embodiments, the antioxidant may be selected from the group consisting of stearyl 3-(3,5-di-tert-butyl-4-hydroxyphenyl) propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide and mixtures thereof.

Colorants, pigments, and dyes suitable for use in conjunction with the nonwoven described herein may, in some embodiments, include, but are not limited to, plant dyes, vegetable dyes, titanium dioxide (which may also act as a delusterant), carbon black, charcoal, silicon dioxide, tartrazine, E102, phthalocyanine blue, phthalocyanine green, quinacridones, perylene tetracarboxylic acid di-imides, dioxazines, perinones disazo pigments, anthraquinone pigments, metal powders, iron oxide, ultramarine, nickel titanate, benzimidazolone orange gl, solvent orange 60, orange dyes, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL Brilliant Yellow K-6G liquid, CARTASOL Yellow K-4GL liquid, CARTASOL Yellow K-GL liquid, CARTASOL Orange K-3GL liquid, CARTASOL Scarlet K-2GL liquid, CARTASOL Red K-3BN liquid, CARTASOL Blue K-5R liquid, CARTASOL Blue K-RL liquid, CARTASOL Turquoise K-RL liquid/granules, CARTASOL Brown K-BL liquid), FASTUSOL® dyes (an auxochrome, available from BASF) (e.g., Yellow 3GL, Fastusol C Blue 74L), and the like, any derivative thereof, and any combination thereof. In some embodiments, solvent dyes may be employed.

Method of Forming the Nanofibers and/or Microfibers

In one embodiment, the nonwoven for the face layer may be formed by spinning to form a spun product. “Island-in-the-sea” refers to fibers forming by extruding at least two polymer components from one spinning die, also referred to as conjugate spinning. As used herein, spinning specifically excludes solution spinning and electrospinning.

In some aspects, the polyamide fiber is melt blown. Melt blowing is advantageously less expensive than electrospinning. Melt blowing is a method type developed for the formation of nonwoven fibers and nonwoven webs; the fibers are formed by extruding a molten thermoplastic polymeric material, or polyamide, through a plurality of small holes. The resulting molten threads or filaments pass into converging high velocity gas streams which attenuate or draw the filaments of molten polyamide to reduce their diameters. Thereafter, the melt blown nanofibers are carried by the high velocity gas stream and deposited on a collecting surface, or forming wire, to form a nonwoven web of randomly disbursed melt blown fibers. The formation of nonwoven fibers and nonwoven webs by melt blowing is well known in the art. See, by way of example, U.S. Pat. Nos. 3,016,599; 3,704,198; 3,755,527; 3,849,241; 3,978,185; 4,100,324; 4,118,531; and 4,663,220.

As is well known, electrospinning has many fabrication parameters that may limit spinning certain materials. These parameters include: electrical charge of the spinning material and the spinning material solution; solution delivery (often a stream of material ejected from a syringe); charge at the jet; electrical discharge of the fibrous membrane at the collector; external forces from the electrical field on the spinning jet; density of expelled jet; and (high) voltage of the electrodes and geometry of the collector. In contrast, the aforementioned nanofibers and products are advantageously formed without the use of an applied electrical field as the primary expulsion force, as is required in an electrospinning method. Thus, the polyamide is not electrically charged, nor are any components of the spinning method. Importantly, the dangerous high voltage necessary in electrospinning methods, is not required with the presently disclosed sound absorbing multi-layer composite or method for forming the same. In some embodiments, the method is a non-electrospin method, e.g. spunbond or melt blown, and resultant sound absorbing multi-layer composite is a non-electrospun product that is produced via a non-electrospin method.

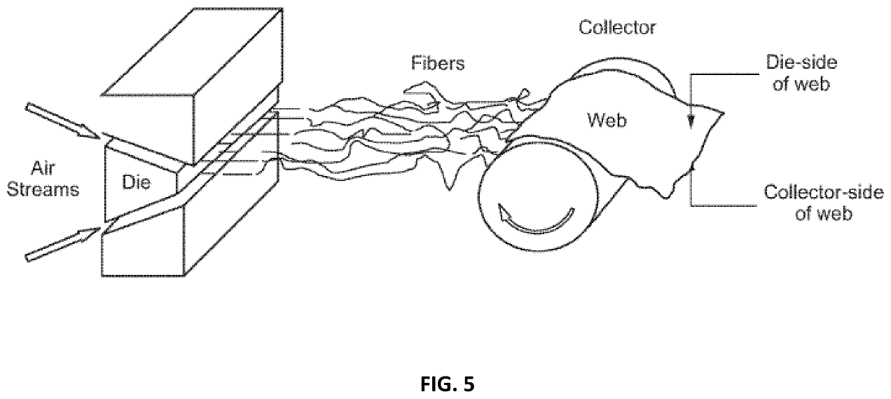

An embodiment of making the nonwoven for the face layer is by way of 2-phase spinning or melt blowing with propellant gas through a spinning channel as is described generally in U.S. Pat. No. 8,668,854. This method includes two phase flow of polymer or polymer solution and a pressurized propellant gas (typically air) to a thin, preferably converging channel. The channel is usually and preferably annular in configuration. It is believed that the polymer is sheared by gas flow within the thin, preferably converging channel, creating polymeric film layers on both sides of the channel. These polymeric film layers are further sheared into fibers by the propellant gas flow. Here again, a moving collector belt may be used and the basis weight of the nonwoven is controlled by regulating the speed of the belt. The distance of the collector may also be used to control fineness of the nonwoven. The method is better understood with reference to FIG. 4.

Beneficially, the use of the aforementioned polyamide precursor in the melt spinning method provides for significant benefits in production rate, e.g., at least 5% greater, at least 10% greater, at least 20% greater, at least 30% greater, at least 40% greater. The improvements may be observed as an improvement in area per hour versus a conventional method, e.g., an electrospin method or a method that does not employ the features described herein. In some cases, the production increase over a consistent period of time is improved. For example, over a given time period, e.g., one hour, of production, the disclosed method produces at least 5% more product than a conventional method or an electrospin method, e.g., at least 10% more, at least 20% more, at least 30% more, or at least 40% more.

FIG. 4 illustrates schematically operation of a system for spinning a nonwoven including a polyamide feed assembly 110, an air feed 1210 a spinning cylinder 130, a collector belt 140 and a take up reel 150. During operation, polyamide melt or solution is fed to spinning cylinder 130 where it flows through a thin channel in the cylinder with high pressure air, shearing the polyamide into nanofibers. Details are provided in the aforementioned U.S. Pat. No. 8,668,854. The throughput rate and basis weight is controlled by the speed of the belt. Optionally, functional additives such as charcoals, copper or the like can be added with the air feed, if so desired.

In an alternate construction of the spinneret used in the system of FIG. 4, particulate material may be added with a separate inlet as is seen in U.S. Pat. No. 8,808,594.

Still yet another methodology which may be employed is melt blowing the polyamide nanofiber and/or microfiber webs disclosed herein (FIG. 5). Melt blowing involves extruding the polyamide into a relatively high velocity, typically hot, gas stream. To produce suitable fibers, careful selection of the orifice and capillary geometry as well as the temperature is required as is seen in: Hassan et al., J Membrane Sci., 427, 336-344, 2013 and Ellison et al., Polymer, 48 (11), 3306-3316, 2007, and, International Nonwoven Journal, Summer 2003, pg 21-28.

U.S. Pat. No. 7,300,272 discloses a fiber extrusion pack for extruding molten material to form an array of nanofibers that includes a number of split distribution plates arranged in a stack such that each split distribution plate forms a layer within the fiber extrusion pack, and features on the split distribution plates form a distribution network that delivers the molten material to orifices in the fiber extrusion pack. Each of the split distribution plates includes a set of plate segments with a gap disposed between adjacent plate segments. Adjacent edges of the plate segments are shaped to form reservoirs along the gap, and sealing plugs are disposed in the reservoirs to prevent the molten material from leaking from the gaps. The sealing plugs can be formed by the molten material that leaks into the gap and collects and solidifies in the reservoirs or by placing a plugging material in the reservoirs at pack assembly. This pack can be used to make nanofibers with a melt blowing system described in the patents previously mentioned.

The spinning methods described herein can form a polyamide nonwoven having a relatively low oxidative degradation index (“ODI”) value. A lower ODI indicates less severe oxidative degradation during manufacture. In some aspects, the ODI may range from 10 to 150 ppm. ODI may be measured using gel permeation chromatography (GPC) with a fluorescence detector. The instrument is calibrated with a quinine external standard. 0.1 grams of nylon is dissolved in 10 mL of 90% formic acid. The solution is then analyzed by GPC with the fluorescence detector. The detector wavelengths for ODI are 340 nm for excitation and 415 nm for emission. In terms of upper limits, the ODI of the nonwoven may be 200 ppm or less, e.g., 180 ppm or less, 150 ppm or less, 125 ppm or less, 100 ppm or less, 75 ppm or less, 60 ppm or less, or 50 ppm or less. In terms of the lower limits, the ODI of the nonwoven may be 1 ppm or greater, 5 ppm or greater, 10 ppm or greater, 15 ppm or greater, 20 ppm or greater, or 25 ppm or greater. In terms of ranges, the ODI of the nonwoven may be from 1 to 200 ppm, from 1 to 180 ppm, from 1 to 150 ppm, from 5 to 125 ppm, from 10 to 100 ppm, from 1 to 75 ppm, from 5 to 60 ppm, or from 5 to 50 ppm.

Additionally, the spinning methods as described herein can result in a relatively low thermal degradation index (“TDI”). A lower TDI indicates a less severe thermal history of the polyamide during manufacture. TDI is measured the same as ODI, except that the detector wavelengths for TDI are 300 nm for excitation and 338 nm for emission. In terms of upper limits, the TDI of the nonwoven may be 4000 ppm or less, e.g., 3500 ppm or less, 3100 ppm or less, 2500 ppm or less, 2000 ppm or less, 1000 ppm or less, 750 ppm or less, or 700 ppm or less. In terms of the lower limits, the TDI of the nonwoven may be 20 ppm or greater, 100 ppm or greater, 125 ppm or greater, 150 ppm or greater, 175 ppm or greater, 200 ppm or greater, or 210 ppm or greater. In terms of ranges, the TDI of the nonwoven may be from 20 to 400 ppm, 100 to 4000 ppm, from 125 to 3500 ppm, from 150 to 3100 ppm, from 175 to 2500 ppm, from 200 to 2000 ppm, from 210 to 1000 ppm, from 200 to 750 ppm, or from 200 to 700 ppm.

TDI and ODI test methods are also disclosed in U.S. Pat. No. 5,411,710. Lower TDI and/or ODI values are beneficial because they indicate that the nanofiber nonwoven product is more durable than products having greater TDI and/or ODI. As explained above, TDI and ODI are measures of degradation and a product with greater degradation would not perform as well. For example, such a product may have reduced dye uptake, lower heat stability, lower life in an acoustic application where the fibers are exposed to heat, pressure, oxygen, or any combination of these, and lower tenacity in industrial fiber applications.

One possible method that may be used in forming a nonwoven with a lower TDI and/or ODI would be to include additives as described herein, especially antioxidants. Such antioxidants, although not necessary in conventional methods, may be used to inhibit degradation. An example of useful antioxidants include copper halides and Nylostab® S-EED® available from Clariant.

In one embodiment the nonwoven for the face layer is air permeable. Preferably the air permeability of the nonwoven for the face layer is less than the air permeability of the non-foam polymeric layer. Accordingly, the nonwoven of the face layer may have an Air Permeability Value that is less than 300 cfm/ft², e.g., less than 275 cfm/ft², less than 250 cfm/ft², less than 225 cfm/ft², less than 200 cfm/ft², less than 175 cfm/ft², less than 150 cfm/ft², or less than 125 cfm/ft², or less than 100 cfm/ft², less than 75 cfm/ft², or less than 50 cfm/ft². Generally, the lower range of the nonwoven of the face layer for the Air Permeability Value may be greater than 5 cfm/ft², greater than 10 cfm/ft², greater than 15 cfm/ft² or greater than 20 cfm/ft². In terms of suitable ranges, the nonwoven of the face layer may have an Air Permeability Value from 5 to 300 cfm/ft², from 10 to 275 cfm/ft², from 15 to 250 cfm/ft², from 15 to 200 cfm/ft², or from 20 to 125 cfm/ft².

The nonwoven may have a mean pore size diameter of 30 microns or less, e.g., 25 microns or less, 20 microns or less, 15 microns or less, 10 microns or less, 5 microns or less, or 1 micron or less. In terms of lower limits, the nonwoven may have a mean pore size diameter of at least 10 nm, e.g., at least 100 nm, at least 500 nm, at least 1 micron, or at least 5 microns. In terms of ranges, the nonwoven may have a mean pore size diameter of 10 nm to 30 microns, e.g., 100 nm to 25 microns, 500 nm to 20 microns, 500 nm to 15 microns, or 1 micron to 10 microns, including all values lying therein.

### Acoustic Applications

The sound absorbing multi-layer composites are primarily useful for sound dampening in transportation and building applications. As described herein, in some aspects, the sound absorbing multi-layer composite need not contain any additional material beyond that of the inventive nonwoven. In other aspects, additional layers and materials, described further herein, may be combined with the non-foam polymeric layer and face layer comprising a nonwoven to form the sound absorbing multi-layer composite. In one embodiment, the properties of the face layer may be targeted to meet the desired air resistivity required for the specific acoustic application. In some embodiments, this target is 1000 Rayls.

In one embodiment, the weighted overall average fiber diameter of the sound absorbing multi-layer composite is from 2 microns to 25 microns, e.g., from 2 microns to 20 microns, from 4 microns to 20 microns, from 5 microns to 20 microns, from 5 microns to 15 microns, from 6 microns to 15 microns, from 8 microns to 12 microns, or from 10 microns to 12 microns. In one embodiment, the face layer has an average fiber diameter that is less than the non-foam polymeric layer.

In one embodiment the sound absorbing multi-layer composite is air permeable. Accordingly, the sound absorbing multi-layer composite may have an Air Permeability Value that is less than 300 cfm/ft², e.g., less than 275 cfm/ft², less than 250 cfm/ft², less than 225 cfm/ft², less than 200 cfm/ft², less than 175 cfm/ft², less than 150 cfm/ft², or less than 125 cfm/ft², or less than 100 cfm/ft², less than 75 cfm/ft², or less than 50 cfm/ft². Generally, the lower range of the sound absorbing multi-layer composite for the Air Permeability Value may be greater than 5 cfm/ft², greater than 10 cfm/ft², greater than 15 cfm/ft² or greater than 20 cfm/ft². In terms of suitable ranges, the sound absorbing multi-layer composite may have an Air Permeability Value from 5 to 300 cfm/ft², from 10 to 275 cfm/ft², from 15 to 250 cfm/ft², from 15 to 200 cfm/ft², or from 20 to 125 cfm/ft².

In exemplary embodiments, the sound absorbing multi-layer composite may have a basis weight from about 10 gram per square meter (gsm) to about 300 gsm. Typically, the non-foam polymeric layer has a basis weight of less than about 300 gsm, e.g., less than about 275 gsm, less than about 250 gsm, less than about 200 gsm, less than about 175 gsm, less than about 150 gsm, or less than about 125 gsm. In some embodiments, the non-foam polymeric layer has a basis weight from about 10 gsm to about 275 gsm, e.g., from 50 gsm to about 275 gsm, from 50 gsm to about 250 gsm, from 50 gsm to about 200 gsm, or from 100 gsm to about 200 gsm.

In one embodiment, the sound absorbing multi-layer composite may be configured to be positioned in the acoustic path so that the sound is at least partially transmitted through the non-foam polymeric layer and absorbed by the face layer. Accordingly, in one embodiment, the non-foam polymeric layer may be adjacent to the face layer to allow one surface of the face layer to be positioned towards the interior of the vehicle. In one embodiment, the face layer and the non-foam polymeric layer are stitch together using a yarn using a needle punch method. The yarn may comprise a polyamide. In some embodiments, the yarn may be single ply or may be multiple ply.

The sound absorbing multi-layer composite comprising the nonwoven provide acceptable sound absorption/dampening. This is demonstrated by sample performance in unique Laboratory Sound Transmission Tests (LSTT). This laboratory screening test uses an amplified source of “white noise” on one side of the sample and the microphone of the decibel meter on the other side of the sample. A noise reduction of at least 5, e.g., at least 10 or at least 15 dB from an incident 90 dB sound level was achieved. Other standardized acoustic tests also show the superior performance per unit of weight of these airlaid materials. For example, an Impedance Tube Sound Absorption Test, either as ASTM E1050-98 with two microphones, or as ASTM C384 with a single movable microphone, has been conducted. Such test may covers a broad frequency range from 100 to 6300 Hz.

A main difference between the standard acoustic tests and the LSTT screening test is that with the Impedance Tube Sound Absorption Test, the microphone(s) is/are on the same side of the sample as the sound source, whereas with the LSTT the sample is between the microphone and the sound source. The Impedance Tube Sound Absorption Test also records details on frequency-related acoustic properties while the LSTT only measures the loudness of the white noise.

In some embodiments, the nonwoven has a sound absorption coefficient (a) as determined by ASTM E1050-98 at 1000 Hz of about 0.5 or greater. The nonwoven may have a sound absorption coefficient (a) as determined by ASTM E1050-98 at 1000 Hz of about 0.55 or greater, particularly when combined with other layers described herein, e.g., about 0.6 or greater, about 0.65 or greater, about 0.70 or greater, about 0.75 or greater, about 0.80 or greater, about 0.85 or greater, about 0.90 or greater, about 0.95 or greater, or about 0.97 or greater.

In some aspects, the sound absorbing multi-layer composite may comprise at least the nonwoven having bulking fibers. In one embodiment, the non-foam polymeric layer may comprise the bulking fibers. The bulking fibers of the nonwoven are fibers that provide volume in the z-direction of the non-woven layer, which extends perpendicularly from the planar dimension of the nonwoven. Types of bulking fibers would include (but are not limited to) fibers with high denier per filament (5 denier per filament or larger), high crimp fibers, hollow-fill fibers, and the like. These fibers provide mass and volume to the material. Some examples of bulking fibers include polyester, polypropylene, and cotton, as well as other low cost fibers. The bulking fibers may have a denier greater than about 12 denier. In another embodiment, the bulking fibers 50 have a denier greater than about 15 denier. The bulking fibers may be staple fibers. In some embodiments, the bulking fibers do not a circular cross section, but are fibers having a higher surface area, including but not limited to, segmented pie, 4DG, winged fibers, tri-lobal etc. It has been shown that the fiber cross-section has an effect on the sound absorption properties of the nonwoven. The nonwoven may comprise the bulking fibers in combination the binder fibers, described herein.

In terms of lower limits, the nonwoven may comprise at least 1 wt. % bulking fibers, e.g., at least 2 wt. %, at least 3 wt. %, or at least 5 wt. %. In terms of upper limits, the nonwoven may comprise no more than 50 wt. % bulking fibers, e.g., no more than 45 wt. %, no more than 40 wt. %, or no more than 35 wt. %. In terms of ranges, the nonwoven may comprise from 1 to 50 wt. % bulking fibers, e.g., from 2 to 45 wt. %, from 3 to 40 wt. %, or from 5 to 35 wt. %. In terms of lower limits, the nonwoven may comprise at least 1 wt. % binder fibers, e.g., at least 2 wt. %, at least 3 wt. %, or at least 5 wt. %. In terms of upper limits, the nonwoven may comprise no more than 50 wt. % binder fibers, e.g., no more than 45 wt. %, no more than 40 wt. %, or no more than 35 wt. %. In terms of ranges, the nonwoven may comprise from 1 to 50 wt. % binder fibers, e.g., from 2 to 45 wt. %, from 3 to 40 wt. %, or from 5 to 35 wt. %. In some aspects, the nonwoven may have a bulking fiber zone and/or a binder zone, wherein the bulking fibers and/or binder fibers are concentrated in certain parts of the nonwoven. In other aspects, the bulking fibers and/or binder fibers may be dispersed throughout the nonwoven.

In some aspects, the face layer may comprise the nonwoven, wherein the nonwoven further comprise multicomponent fibers. Such fibers are described in U.S. Pat. No. 6,855,422, which is hereby incorporated by reference in its entirety. Such materials serve as phase changer or temperature regulating materials. Generally, phase change materials have the ability to absorb or release thermal energy to reduce or eliminate heat flow. In general, a phase change material may comprise any substance, or mixture of substances, that has the capability of absorbing or releasing thermal energy to reduce or eliminate heat flow at or within a temperature stabilizing range. The temperature stabilizing range may comprise a particular transition temperature or range of transition temperatures. Phase change materials used in conjunction with various embodiments of the nonwoven structure will be capable of inhibiting a flow of thermal energy during a time when the phase change material is absorbing or releasing heat, typically as the phase change material undergoes a transition between two states, such as, for example, liquid and solid states, liquid and gaseous states, solid and gaseous states, or two solid states. This action is typically transient, and will occur until a latent heat of the phase change material is absorbed or released during a heating or cooling process. Thermal energy may be stored or removed from the phase change material, and the phase change material typically can be effectively recharged by a source of heat or cold. By selecting an appropriate phase change material, the multi-component fiber may be designed for use in any one of numerous products.

Bicomponent fibers may incorporate a variety of polymers as their core and sheath components. Bicomponent fibers that have a polyethylene or modified polyethylene sheath typically have a polyethylene terephthalate or polypropylene core. In some embodiments, the bicomponent fiber has a core made of polyester and sheath made of polyethylene. Alternatively, a multi-component fiber with a polypropylene or modified polypropylene or polyethylene sheath or a combination of polypropylene and modified polyethylene as the sheath or a copolyester sheath wherein the copolyester is isophthalic acid modified polyethylene terephthalate typically with a polyethylene terephthalate or polypropylene core, or a polypropylene sheath—polyethylene terephthalate core and polyethylene sheath—polyethylene core and co-polyethylene terephthalate sheath fibers may be employed.

In some aspects, the face layer may comprise the nonwoven, wherein the nonwoven comprises a plurality of roped polyamide fiber bundles. In some aspects, the polyamide fibers are polyamide nanofibers. In some aspects, at least 50% by number of the nanofibers may be oriented within 45 degrees of the length axis of the roped fiber bundles. The nanofibers in each roped bundle may be entangled together. The roped fiber bundles may be randomly oriented within the nonwoven. Without being bound by theory, it is believed that the roped fiber bundles form a nonwoven with increased loft and increased porosity but without introducing bulk to the nonwoven. The loft of the nonwoven may be relatively high, resulting in a relatively low density, e.g., of less than 0.2 g/cm³, e.g., less than 0.1 g/cm³, or less than 0.05 g/cm³. In other aspects, the density of the nonwoven may be greater than 0.2 g/cm³, e.g., greater than 0.3 g/cm³, greater than 0.5 g/cm³, or greater than 1 g/cm³. The density of the nonwoven may be selected based on the desired sound dampening of the face layer and overall the sound absorbing multi-layer composite. Additionally, the density of the nonwoven may be balanced with the final RV of the nonwoven.

If necessary to increase the tensile strength, shear, burst, or peel properties of the nonwoven, the nanofibers may be stabilized by stitch stabilizing, point bonding, ultrasonic bonding, or other methods.

The roped bundles may comprise more than one range of sizes of fibers, e.g., different sized nanofibers, microfibers, different sized microfibers, or combinations thereof. Further, binder fibers may be included in the nonwoven. Binder fibers are fibers that form an adhesion or bond with other fibers. In some aspects, binder fibers are heat activated and may include low melt fibers and bi-component fibers (such as side-by-side or core and sheath fibers with a lower sheath melting temperature). An example of a specific binder fiber includes polyester core and sheath fibers with a lower melt temperature sheath. Including heat activated binder fibers allows for the nonwoven layer to be subsequently molded to part shapes, e.g., for use in automotive hood liners, engine compartment covers, ceiling tiles, office panels, etc. The binder fibers may be staple fibers.

Additional nanofibers and/or microfibers may also be included in the nonwoven. These may include, but are not limited to a second type of nanofiber fiber having a different denier, staple length, composition, or melting point, and a fire resistant or fire retardant fiber. The fiber may also be an effect fiber, providing benefit a desired aesthetic or function. These effect fibers may be used to impart color, chemical resistance (such as polyphenylene sulfide fibers and polytetrafluoroethylene fibers), moisture resistance (such as polytetrafluoroethylene fibers and topically treated polymer fibers), or others. In some embodiments, the nonwoven contains fire resistant fibers. As used herein, fire retardant fibers shall mean fibers having a Limiting Oxygen Index (LOI) value of 20.95 or greater, as determined by ISO 4589-1. Types of fire retardant fibers include, but are not limited to, fire suppressant fibers and combustion resistant fibers. Fire suppressant fibers are fibers that meet the LOI by consuming in a manner that tends to suppress the heat source. In one method of suppressing a fire, the fire suppressant fiber emits a gaseous product during consumption, such as a halogenated gas. Examples of fiber suppressant fibers include modacrylic, PVC, fibers with a halogenated topical treatment, and the like. Combustion resistant fibers are fibers that meet the LOI by resisting consumption when exposed to heat. Examples of combustion resistant fibers include silica impregnated rayon such as rayon sold under the mark VISIL®, partially oxidized polyacrylonitrile, polyaramid, para-aramid, carbon, meta-aramid, melamine and the like.

Any or all of the fibers in the nonwoven may additionally contain additives. Suitable additives include, but are not limited to, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluoropolymers. One or more of the above-described additives may be used to reduce the weight and/or cost of the resulting fiber and layer, adjust viscosity, or modify the thermal properties of the fiber or confer a range of physical properties derived from the physical property activity of the additive including electrical, optical, density-related, liquid barrier or adhesive tack related properties. In some automotive and appliance applications, the acoustic insulation desirably has a degree of water repellency. Door panels, wheel wells, and the engine compartment are typical applications requiring insulation, which will not retain significant amounts of water. Any of the known waterproofing agents like MAGNASOFT® Extra Emulsion by GE Silicones of Friendly, W. Va., for example, are operable. Also desired for most insulation applications is resistance to the growth of mold. To achieve this property either the matrix fiber and/or binder or the airlaid insulation material may be treated with any of a number of known mildewcides, such as, for example, 2-iodo-propynol-butyl carbamate, diiodomethyl-p-tolylsulfone, zinc pyrithione, N-octyl chloroisothiazalone, and octadecylaminodimethyltrimethoxysilylipropyl ammonium chloride used with chloropropyltrimethyoxysilane, to name a few. Other biocides that may be used are KATHON® based on isothiazolone chemistry and KORDEK® an aqueous-based microbicide, both from Rohm and Haas.

In some embodiments, wax or any other blooming agent that provides lubrication, may be added to the nanofibers as an additive. The wax tends to bloom to the surface of the nanofiber during extrusion. The wax, such as Paracin (Paricin® 285 (available from Vertellus), N,N′-Ethylene bis-12-hydroxystearamide, is a brittle wax-like solid formed from the reaction of an amine with hydroxystearic acid), or polymer blends reduce the cohesion between the individual fibers or otherwise facilitate increased loft. It has been observed that the addition of wax further enhances the entanglement of the nanofibers into larger roped bundles, thereby increasing the overall loft of the nonwoven. The decreased adhesion allows the fibers to more thoroughly entangle mechanically through the air stream. The wax tends to bloom to the surface of the nanofiber during fiber formation, reducing fiber-fiber bonding and web compaction during collection. A higher percentage of fibers were part of larger rope bundles when a wax additive was used.

In some embodiments, the nonwoven further contains an additional layer on at least one side forming a nonwoven composite. The additional layer may be any suitable layer for the composite. In some embodiments, the additional layer is located adjacent to a first side of the nonwoven. In another embodiment, a second additional layer may be located adjacent the second side of the nonwoven. In further embodiments, more additional layers may be stacked on one or both sides of the nonwoven.

The additional layer may be, but is not limited to, a woven textile, a knit textile, a nonwoven textile, and a film. In the embodiments where the additional layer is a textile, the textile may be of any suitable construction and composition. The textile may be made out of a yarn or material that is selected to give the desired tensile, abrasion, and ductile characteristics. For a small article, the tensile strength may not be as important as when the article is a tube that may be several thousand feet long and will be wound and unwound. In some embodiments, the textile is an open construction to allow for the passing of air/gases/liquids or other materials through the textile to reach the nonwoven. The materials forming the additional layer may be any of the polymers disclosed herein, as well as any other thermoplastic or thermoset, natural or synthetic material.

Some suitable materials for the yarns/fibers in the additional layer include polyamide, aramid (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, polyacrylic, polytrimethylene terephthalate (PTT), polycyclohexane dimethylene terephthalate (PCT), polybutylene terephthalate (PBT), PET modified with polyethylene glycol (PEG), polylactic acid (PLA), polytrimethylene terephthalate, nylons (including nylon 6 and nylon 6,6); regenerated cellulosics (such as rayon or Tencel); elastomeric materials such as spandex; high-performance fibers such as the polyaramids, and polyimides natural fibers such as cotton, linen, ramie, and hemp, proteinaceous materials such as silk, wool, and other animal hairs such as angora, alpaca, and vicuna, fiber reinforced polymers, thermosetting polymers, blends thereof, and mixtures thereof.

In some embodiments, the additional layer may contain some or all high tenacity yarns or fibers. These high modulus fibers may be any suitable fiber having a modulus of at least about 4 GPa, more preferably greater than at least 15 GPa, more preferably greater than at least 70 GPa. Some examples of suitable fibers include glass fibers, aramid fibers, and highly oriented polypropylene fibers as described in U.S. Pat. No. 7,300,691, bast fibers, and carbon fibers. A non-inclusive listing of suitable fibers for the high modulus fibers of the first layer include, fibers made from highly oriented polymers, such as gel-spun ultrahigh molecular weight polyethylene fibers (e.g., SPECTRA® fibers from Honeywell Advanced Fibers of Morristown, N.J. and DYNEEMA® fibers from DSM High Performance Fibers Co. of the Netherlands), melt-spun polyethylene fibers (e.g., CERTRAN® fibers from Celanese Fibers of Charlotte, N.C.), melt-spun nylon fibers (e.g., high tenacity type nylon 6,6 fibers from Invista of Wichita, Kans.), melt-spun polyester fibers (e.g., high tenacity type polyethylene terephthalate fibers from Invista of Wichita, Kans.), and sintered polyethylene fibers (e.g., TENSYLON® fibers from ITS of Charlotte, N.C.). Suitable fibers also include those made from rigid-rod polymers, such as lyotropic rigid-rod polymers, heterocyclic rigid-rod polymers, and thermotropic liquid-crystalline polymers. Suitable fibers made from lyotropic rigid-rod polymers include aramid fibers, such as poly(p-phenyleneterephthalamide) fibers (e.g., KEVLAR® fibers from DuPont of Wilmington, Del. and TWARON® fibers from Teijin of Japan) and fibers made from a 1:1 copolyterephthalamide of 3,4′-diaminodiphenylether and p-phenylenediamine (e.g., TECHNORA® fibers from Teijin of Japan). Suitable fibers made from heterocyclic rigid-rod polymers, such as p-phenylene heterocyclics, include poly(p-phenylene-2,6-benzobisoxazole) fibers (PBO fibers) (e.g., ZYLON® fibers from Toyobo of Japan), poly(p-phenylene-2,6-benzobisthiazole) fibers (PBZT fibers), and poly[2,6-diimidazo[4,5-b:4′,5′-e]pyridinylene-1,4-(2,5-dihydroxy)phenylene] fibers (PIPD fibers) (e.g., M5® fibers from DuPont of Wilmington, Del.). Suitable fibers made from thermotropic liquid-crystalline polymers include poly(6-hydroxy-2-napthoic acid-co-4-hydroxybenzoic acid) fibers (e.g., VECTRAN® fibers from Celanese of Charlotte, N.C.). Suitable fibers also include boron fibers, silicon carbide fibers, alumina fibers, glass fibers, carbon fibers, such as those made from the high temperature pyrolysis of rayon, polyacrylonitrile (e.g., OFF® fibers from Dow of Midland, Mich.), and mesomorphic hydrocarbon tar (e.g., THORNEL® fibers from Cytec of Greenville, S.C.). In another embodiment, the additional layer contains yarns and/or fibers containing thermoplastic polymer, cellulose, glass, ceramic, and mixtures thereof.

In some embodiments, the additional layer is a woven textile. The woven textile may also be, for example, plain, satin, twill, basket-weave, poplin, jacquard, and crepe weave textiles. Preferably, the woven textile is a plain weave textile. It has been shown that a plain weave textile has good abrasion and wear characteristics. A twill weave has been shown to have good properties for compound curves so may also be preferred for some textiles. The end count in the warp direction is between 35 and 70 in some embodiments. The denier of the warp yarns is between 350 and 1200 denier in some embodiments. In some embodiments, the woven textile is air permeable.

In another embodiment, the additional layer is a knit textile, for example a circular knit, reverse plaited circular knit, double knit, single jersey knit, two-end fleece knit, three-end fleece knit, terry knit or double loop knit, weft inserted warp knit, warp knit, and warp knit with or without a micro-denier face.

In another embodiment, the additional layer is a multi-axial, such as a tri-axial textile (knit, woven, or nonwoven). In another embodiment, the additional layer is a bias textile. In another embodiment, the additional layer is a scrim.

In another embodiment, the additional layer is a nonwoven textile. The term “nonwoven textile” refers to structures incorporating a mass of yarns that are entangled and/or heat fused so as to provide a coordinated structure with a degree of internal coherency. Nonwoven textiles for use as the textile may be formed from many processes such as for example, melt spun processes, hydroentangling processes, melt blown processes, spunbond processes, composites of the same mechanically entangled processes, stitch-bonded and the like. In another embodiment, the textile is a unidirectional textile and may have overlapping yarns or may have gaps between the yarns.

In another embodiment, the additional layer is a film, preferably a thermoplastic film. In some embodiments, the thermoplastic film is air impermeable. In another embodiment, the thermoplastic film has some air permeability due to apertures including perforations, slits, or other types of holes in the film. The thermoplastic film can have any suitable thickness, density, or stiffness. Preferably, the thickness of the film is between less than 2 and 50 microns thick, more preferably the film has a thickness of between about 5 and 25 microns, more preferably between about 5 and 15 microns thick. In some embodiments, the thermoplastic film may contain any suitable additives or coatings, such as an adhesion promoting coating. For the sound absorbing multi-layer composite, the film thickness and mechanical properties are chosen to absorb acoustic energy, while minimizing reflections of acoustic energy.

The additional layer may be attached by any known means to the nonwoven or may simply have been laid on and not attached by any means. In some embodiments, the fibers in the nonwoven provide for some adhesion by binding the nonwoven and the additional layer when melted and subsequently cooled. In another embodiment, an adhesive layer may be used between the additional layer and the nonwoven. The adhesive layer may be any suitable adhesive, including but not limited to a water-based adhesive, a solvent-based adhesive, and a heat or UV activated adhesive. The adhesive may be applied as a free standing film, a coating (continuous or discontinuous, random or patterned), a powder, or any other known means. In another embodiment, the additional layer may be attached to the nonwoven by attachment devices such as mechanical fasteners like screws, nails, clips, staples, stitching, thread, hook and loop materials, etc. In the case of the consolidated nanofiber nonwoven composite, the additional layer may be applied at suitable time during manufacture, including before or after consolidation of the nanofiber nonwoven.

The nonwoven may further comprise an auxiliary layer. The auxiliary layer may be a moldable thermoplastic or thermosetting polymeric binder material. In some aspects, the auxiliary layer contains a plastic material. When the plastic material is derived from latex solids it may contain a filler which was incorporated into the wet latex prior to application to the nonwoven. Suitable fillers include materials with anionic moieties such as, for example, sulfides, oxides, carbides, iodides, borides, carbonates or sulfates, in combination with one or more of vanadium, tantalum, tellurium, thorium, tin, tungsten, zinc, zirconium, aluminum, antimony, arsenic, barium, calcium, cerium, chromium, copper, europium, gallium, indium, iron, lead, magnesium, manganese, molybdenum, neodymium, nickel, niobium, osmium, palladium, platinum, rhodium, silver, sodium, or strontium. Preferred fillers include calcium carbonate, barium sulfate, lead sulfide, lead iodide, thorium boride, lead carbonate, strontium carbonate and mica.

The auxiliary layer may have a basis weight from about 50 gsm to about 400 gsm. In other embodiments, the plastic material has a basis weight from about 75 gsm to about 400 gsm; others, a basis weight from about 100 gsm to about 400 gsm; others, a basis weight from about 125 gsm to about 400 gsm; still others, a basis weight from about 150 gsm to about 400 gsm. The basis weight of the auxiliary layer may depend upon the nature of the plastic material and the nature and amount of filler used.

The sound absorbing multi-layer composite may also contain any additional layers for physical or aesthetic purposes. Suitable additional layers include, but are not limited to, a nonwoven textile, a woven textile, a knitted textile, a film, a paper layer, an adhesive-backed layer, a foil, a mesh, an elastic textile (i.e., any of the above-described woven, knitted or nonwoven textiles having elastic properties), an apertured web, an adhesive-backed layer, an aesthetic surface, or any combination thereof. Other suitable additional layers include, but are not limited to, a color-containing layer (e.g., a print layer); one or more additional sub-micron fiber layers having a distinct average fiber diameter and/or physical composition; one or more secondary fine fiber layers for additional insulation performance (such as a melt-blown web or a fiberglass textile); layers of particles; foil layers; films; decorative textile layers; membranes (i.e., films with controlled permeability, such as dialysis membranes, reverse osmosis membranes, etc.); netting; mesh; wiring and tubing networks (i.e., layers of wires for conveying electricity or groups of tubes/pipes for conveying various fluids, such as wiring networks for heating blankets, and tubing networks for coolant flow through cooling blankets); or a combination thereof.

In some embodiments, the sound absorbing multi-layer composite may be further consolidated before their end use. Consolidation is the process of using heat and/or pressure to create internal binding points throughout the nonwoven and/or the nonwoven composite. After consolidation, the resultant structure is typically thinner. At least a portion of the nanofibers within a roped fiber bundle are adhered (typically through partially melting and cooling) to other nanofibers within the roped fiber bundle. At least a portion of the roped fiber bundles are adhered to other roped fiber bundles. At least a portion of the nanofibers that are not in roped fiber bundles are adhered to other “loose” nanofibers or to roped fiber bundles. Consolidating the nanofiber web allows for controlling the porosity and pore sizes to a set amount. This can be advantageous for sound absorbing multi-layer composite bonded to a strengthening scrim like a weft inserted warp knit scrim.

The porosity and the average pore size of the nanofiber nonwoven web can be tuned by consolidating them at different pressures. At the same basis weight, consolidated nanofiber nonwovens have a higher number of small pores when compared to a consolidated sample containing larger fibers. Also of note, under consolidation pressure nanofibers can begin to fuse together even at room temperature. Nanofiber webs containing roped bundles of nanofibers may not consolidate or fuse together in the same manner under similar consolidation pressure.

The sound absorbing multi-layer composite may further comprise one or more attachment devices to enable attachment to a substrate or other surface. In addition to adhesives, other attachment devices may be used such as mechanical fasteners like screws, nails, clips, staples, stitching, thread, hook and loop materials, etc.

The one or more attachment devices may be used to attach the nonwoven and the nonwoven composite to a variety of substrates. Exemplary substrates include, but are not limited to, a vehicle component; an interior of a vehicle (i.e., the passenger compartment, the motor compartment, the trunk, etc.); a wall of a building (i.e., interior wall surface or exterior wall surface); a ceiling of a building (i.e., interior ceiling surface or exterior ceiling surface); a building material for forming a wall or ceiling of a building (e.g., a ceiling tile, wood component, gypsum board, etc.); a room partition; a metal sheet; a glass substrate; a door; a window; a machinery component; an appliance component (i.e., interior appliance surface or exterior appliance surface); filter component; a surface of a pipe or hose; a computer or electronic component; a sound recording or reproduction device; a housing or case for an appliance, computer, etc. Attaching the nonwoven and/or the nonwoven composite thereby provides acoustic absorption.

The sound absorbing multi-layer composite may be provided by providing a polyamide composition, spinning the polyamide composition into a plurality of fibers having an average fiber diameter of less than 25 microns, forming the fibers into a nonwoven, and optionally combining the nonwoven with at least one additional layer or material. The sound absorbing multi-layer composite may then be used to provide sound attenuation in a building or vehicle by providing a structural cavity in need of sound attenuation and applying or attaching the sound absorbing multi-layer composite thereto.

### EMBODIMENTS

Embodiment 1 is a sound absorbing multi-layer composite for a vehicle that reduces sounds along an acoustic path comprising a non-foam polymeric layer having a thickness of at least 1 mm, and a face layer for dissipating sound energy and made of a nonwoven polymer comprising at least 60% of a polyamide containing an aliphatic diamine having 6 or more carbon atoms and an aliphatic diacid having 6 or more carbon atoms, and having at least one surface that is positioned towards to the interior of the vehicle; wherein the composite is configured to be positioned in the acoustic path so that the sound is at least partially transmitted through the non-foam polymeric layer and at least partially absorbed by the face layer; wherein the weighted overall average fiber diameter of the composite is from 2 microns to 25 microns.

Embodiment 2 is a component for a vehicle comprising a non-foam polymeric layer having a thickness of at least 1 mm and a face layer for dissipating sound energy and made of a nonwoven polymer comprising at least 60% of a polyamide containing an aliphatic diamine having 6 or more carbon atoms and an aliphatic diacid having 6 or more carbon atoms, and having at least one surface that is positioned towards the interior of the vehicle, wherein the weighted overall average fiber diameter of the composite is from 2 microns to 25 microns, and wherein the component comprises a headliner, trim, panel, or board.

Embodiment 3 is an embodiment of any the preceding embodiments wherein the face layer comprises a first layer and a second layer.

Embodiment 4 is an embodiment of embodiment 3 wherein the first layer comprises a melt blown nonwoven polymer comprising at least 60% of a polyamide containing an aliphatic diamine having 6 or more carbon atoms and an aliphatic diacid having 6 or more carbon atoms.

Embodiment 5 is an embodiment of embodiment 3 wherein the first layer comprises a spun bond nonwoven polymer comprising at least 60% of a polyamide containing an aliphatic diamine having 6 or more carbon atoms and an aliphatic diacid having 6 or more carbon atoms.

Embodiment 6 is an embodiment of any one of embodiments 4 or 5, wherein the nonwoven of the first layer has an average fiber diameter from 200 to 900 nm.

Embodiment 7 is an embodiment of any one of embodiments 4 or 5, wherein the nonwoven of the first layer has an average fiber diameter that is greater than 1 micron.

Embodiment 8 is an embodiment of embodiment 3 wherein the second layer comprises a melt blown nonwoven polymer comprising at least 60% of a polyamide containing an aliphatic diamine having 6 or more carbon atoms and an aliphatic diacid having 6 or more carbon atoms.

Embodiment 9 is an embodiment of embodiment 3 wherein the second layer comprises a spun bond nonwoven polymer comprising at least 60% of a polyamide containing an aliphatic diamine having 6 or more carbon atoms and an aliphatic diacid having 6 or more carbon atoms.

Embodiment 10 is an embodiment of any one of embodiments 8 or 9, wherein the nonwoven of the first layer has an average fiber diameter from 200 to 900 nm.

Embodiment 11 is an embodiment of any one of embodiments 8 or 9, wherein the nonwoven of the first layer has an average fiber diameter that is greater than 1 micron.

Embodiment 12 is a sound absorbing multi-layer composite for a vehicle that reduces sounds along an acoustic path comprising a non-foam polymeric layer having a thickness of at least 1 mm; and a face layer for dissipating sound energy, wherein the face layer comprises a first and second layer, the first layer being made of a nonwoven polymer comprising at least 60% of a polyamide containing an aliphatic diamine having 6 or more carbon atoms and an aliphatic diacid having 6 or more carbon atoms, having an average fiber diameter that is greater than 1 micron and wherein at least one surface of the second layer is positioned towards the interior of the vehicle; wherein the composite is configured to be positioned in the acoustic path so that the sound is at least partially transmitted through the non-foam polymeric layer and at least partially absorbed by the face layer; wherein the weighted overall average fiber diameter of the composite is from 2 microns to 25 microns.

Embodiment 13 is a sound absorbing multi-layer composite for a vehicle that reduces sounds along an acoustic path comprising a non-foam polymeric layer having a thickness of at least 1 mm; and a face layer for dissipating sound energy, wherein the face layer comprises a first and second layer, the first layer being made of a nonwoven polymer comprising at least 60% of a polyamide containing an aliphatic diamine having 6 or more carbon atoms and an aliphatic diacid having 6 or more carbon atoms, having an average fiber diameter from 200 to 900 nm and wherein at least one surface of the second layer is positioned towards the interior of the vehicle; wherein the composite is configured to be positioned in the acoustic path so that the sound is at least partially transmitted through the non-foam polymeric layer and at least partially absorbed by the face layer; wherein the weighted overall average fiber diameter of the composite is from 2 microns to 25 microns.

Embodiment 14 is a sound absorbing multi-layer composite for a vehicle that reduces sounds along an acoustic path comprising a non-foam polymeric layer having a thickness of at least 1 mm; and a face layer for dissipating sound energy, wherein the face layer comprises a first and second layer, the first layer being made of a nonwoven polymer comprising at least 60% of a polyamide containing an aliphatic diamine having 6 or more carbon atoms and an aliphatic diacid having 6 or more carbon atoms, having an average fiber diameter that is greater than 1 micron and the second layer having an average fiber diameter that is greater than 1 micron and wherein at least one surface of the second layer is positioned towards the interior of the vehicle; wherein the composite is configured to be positioned in the acoustic path so that the sound is at least partially transmitted through the non-foam polymeric layer and at least partially absorbed by the face layer; wherein the weighted overall average fiber diameter of the composite is from 2 microns to 25 microns; wherein at least one the first or second layers is a spun bond nonwoven.

Embodiment 15 is an embodiment of any the preceding embodiments wherein the face layer comprises at least one low reflectivity metal, preferably copper or zinc.

Embodiment 16 is an embodiment of any the preceding embodiments wherein the non-foam polymeric layer comprises at least one low reflectivity metal, preferably copper or zinc.

Embodiment 17 is an embodiment of any the preceding embodiments further comprising a yarn for stitching the nonfoam polymeric layer to the face layer.

Embodiment 18 is an embodiment of any the preceding embodiments wherein the composite has an air permeability of less than 200 cfm/ft².

Embodiment 19 is an embodiment of any the preceding embodiments wherein the air permeability of the non-foam polymeric layer is greater than the face layer.

Embodiment 20 is an embodiment of any the preceding embodiments wherein the face layer has a density of less than 0.2 g/cm³.

Embodiment 21 is an embodiment of any the preceding embodiments wherein the non-foam polymeric layer comprises bulking fibers.

Embodiment 22 is an acoustic media comprising a nonwoven, wherein the nonwoven comprises melt-spun polyamide fibers having an average fiber diameter of less than 25 microns.

Embodiment 23 is the acoustic media according to Embodiment 22, wherein the nonwoven comprises a plurality of roped polyamide fiber bundles.

Embodiment 24 is the acoustic media according to Embodiments 22 or 23, wherein the nonwoven further comprises one or more layers in addition to the polyamide fibers.

Embodiment 25 is the acoustic media according to any one Embodiments 22-24, further comprising bulking fibers.

Embodiment 26 is the acoustic media according to any one Embodiments 22-25, further comprising binder fibers.

Embodiment 27 is the acoustic media according to any one Embodiments 22-26, further comprising an additive, wherein the additive is at least one of a filler, stabilizer, plasticizer, tackifier, flow control agent, cure rate retarder, adhesion promoter, adjuvant, impact modifier, expandable microsphere, thermally conductive particle, electrically conductive particle, silica, glass, clay, talc, pigment, colorant, glass bead or bubble, antioxidant, optical brightener, antimicrobial agent, surfactant, fire retardant, and fluoropolymer.

Embodiment 28 is the acoustic media according to any one Embodiments 22-27, wherein the acoustic media has a sound transmission reduction of at least 5 decibel in an LSTT sound transmission test.

Embodiment 29 is the acoustic media according to any one Embodiments 22-28, further comprising a support layer, wherein the support layer is at least one of a non-woven fabric, a woven fabric, a knitted fabric, a foam layer, a film, a paper layer, an adhesive-backed layer, a spun-bonded fabric, a meltblown fabric, and a carded web of staple length fibers.

Embodiment 30 is the acoustic media according to any one Embodiments 22-29, wherein the nonwoven is adhered to a substrate.

Embodiment 31 is the acoustic media according to any one Embodiments 22-30, wherein the melt point of the nonwoven is 225° C. or greater.

Embodiment 32 is the acoustic media according to any one Embodiments 22-31, wherein the melt-spun polyamide fibers are nanofibers having an average fiber diameter of 1000 nanometers or less.

Embodiment 33 is the acoustic media according to any one Embodiments 22-32, wherein no more than 20% of the nanofibers have a diameter of greater than 700 nanometers.

Embodiment 34 is the acoustic media according to any one Embodiments 22-33, wherein the polyamide fibers comprises nylon 66 or nylon 6/66.

Embodiment 35 is the acoustic media according to any one Embodiments 22-34, wherein the polyamide fibers comprise a high temperature nylon.

Embodiment 36 is the acoustic media according to any one Embodiments 22-35, wherein the polyamide fibers comprises N6, N66, N6T/66, N612, N6/66, N6I/66, N66/6I/6T, N11, and/or N12, wherein “N” means Nylon.

Embodiment 37 is the acoustic media according to any one Embodiments 22-36, wherein the nonwoven has an Air Permeability Value of less than 600 CFM/ft².

Embodiment 38 is the acoustic media according to any one Embodiments 22-37, wherein the nonwoven has a basis weight of 200 GSM or less.

Embodiment 39 is the acoustic media according to any one Embodiments 22-38, wherein the media further comprises an auxiliary layer containing a plastic material having a basis weight from about 50 to about 700 gsm.

Embodiment 40 is the acoustic media according to any one Embodiments 22-39, wherein the acoustic media has a sound absorption coefficient of at least 0.5 as determined by ASTM E1050-98 at 1000 Hz.

Embodiment 41 is the acoustic media according to any one Embodiments 22-40, wherein the nonwoven has a TDI of at least 20 ppm and an ODI of at least 1 ppm.

Embodiment 42 is the acoustic media according to any one Embodiments 22-41, wherein the nonwoven is free of solvent.

Embodiment 43 is the acoustic media according to any one Embodiments 22-42, wherein the nonwoven comprises less than 5000 ppm solvent.

Embodiment 44: An acoustic media comprising a nonwoven, the nonwoven comprising a polyamide which is spun into fibers with an average diameter of 25 micrometers or less and formed into said nonwoven, wherein the nonwoven has a mean pore size diameter of 30 microns or less and an air permeability of 600 cfm/square foot or less.

Embodiment 45: A method of making an acoustic media, the method comprising: (a) providing a polyamide composition, (b) spinning the polyamide composition into a plurality of fibers having an average fiber diameter of less than 25 microns; (c) forming the fibers into a nonwoven; and (d) optionally combining the nonwoven with at least one additional layer or material to form an acoustic media.

Embodiment 46: The method of making the acoustic media according to Embodiment 24, wherein the moisture content of the polyamide composition is from 10 ppm to 5 wt. %.

Embodiment 47: The method of making the acoustic media according to any of Embodiments 45 or 46, wherein the polyamide composition is melt spun by way of melt-blowing through a die into a high velocity gaseous stream.

Embodiment 48: The method of making the acoustic media according to any of Embodiments 45-47, wherein the polyamide composition is melt-spun by 2-phase propellant-gas spinning, including extruding the polyamide composition in liquid form with pressurized gas through a fiber-forming channel.

Embodiment 49: The method of making the acoustic media according to any of Embodiments 45-48, wherein the nonwoven is formed by collecting the fibers on a moving belt.

Embodiment 50: The method of making the acoustic media according to any of Embodiments 45-49, wherein the nanofiber nonwoven has a basis weight of 150 GSM or less.

Embodiment 51: The method of making the acoustic media according to any of Embodiments 45-50, wherein the relative viscosity of the polyamide in the nonwoven is reduced as compared to the polyamide composition prior to spinning and forming the nonwoven.

Embodiment 52: The method of making the acoustic media according to any of Embodiments 45-51, wherein the relative viscosity of the polyamide in the nonwoven is the same or increased as compared to the polyamide composition prior to spinning and forming the nonwoven.

Embodiment 53: An acoustic media comprising a nanofiber nonwoven, wherein the nanofiber nonwoven comprises a nylon 66 polyamide which is melt spun into nanofibers and formed into said nonwoven product, wherein the product has a TDI of at least 20 ppm and an ODI of at least 1 ppm.

Embodiment 54: An acoustic media comprising a nonwoven, wherein the nonwoven comprises a nylon 66 polyamide which is melt spun into fibers and formed into said nonwoven, wherein no more than 20% of the fibers have a diameter of greater than 25 microns.

Embodiment 55: A method for providing sound attenuation in a building or vehicle, the method comprising: (a) providing a structural cavity or surface of the building or vehicle, and (b) applying or attaching thereto an acoustic media according to any of the preceding embodiments.

The present disclosure is further understood by the following non-limiting examples.

### EXAMPLES

In Examples 1-6, sound absorbing multi-layer composites were prepared. The composite comprised nonfoam polymeric layer comprising a lofty polyester (PE) nonwoven having a thickness of about 2.54 cm (about 1 inch), referred to as a scrim in Table 1. Various nanofiber, microfiber or spunbond polyamide 66 fibers (n-PA66) were used as the face layer. The nanofiber nonwoven polyamide 66 fibers had an average fiber diameter of about 500 nanometers. The microfiber nonwoven polyamide 66 fibers (m-PA66) had an average fiber diameter of about 1.2 microns. The spundbond nonwoven polyamide 66 fibers (s-PA66) had an average fiber diameter of about 23.8 microns. The various layers are needle punched using a yarn stitched through the non-foam polymeric layer and face layer. Examples 2, 3, and 5 used multiple layers for the face layer and the arrangement is shown in Table 1, where the acoustic path travels from the PE scrim towards the various face layers. In addition, the basis weight, weighted overall average fiber diameter, air permeability are reported in Table 1. In addition, the amount of the low reflectivity metals are also reported in Table 1.

TABLE 1

| Example | Scrim | 1 | 2 | 3 | 4 | 5 | 6 |
|---|---|---|---|---|---|---|---|
| Composite | PE | n-PA66 | n-PA66 | n-PA66 | s-PA66 | s-PA66 | m-PA66 |
| | | PE | s-PA66 | m-PA66 | PE | m-PA66 | PE |
| | | | PE | PE | | PE | |
| Total Basis | 63.9 | 102.6 | 182.5 | 164.7 | 141.6 | 214.4 | 131.6 |
| Weight (gsm) | | | | | | | |
| Weighted overall | 11.6 | 7.0 | 10.2 | 8.1 | 22.3 | 14.2 | 10.2 |
| average fiber | | | | | | | |
| diameter | | | | | | | |
| (microns) | | | | | | | |
| Zinc (ppm) | 15 | 275 | 341 | 366 | 270 | 370 | 273 |
| Copper (ppm) | 1 | 7 | 11 | 14 | 8 | 13 | 12 |
| Air Permeability | 563.9 | 116.4 | 35.2 | 23.5 | 192.8 | 48.7 | 55.55 |
| (cfm/sqft) | | | | | | | |

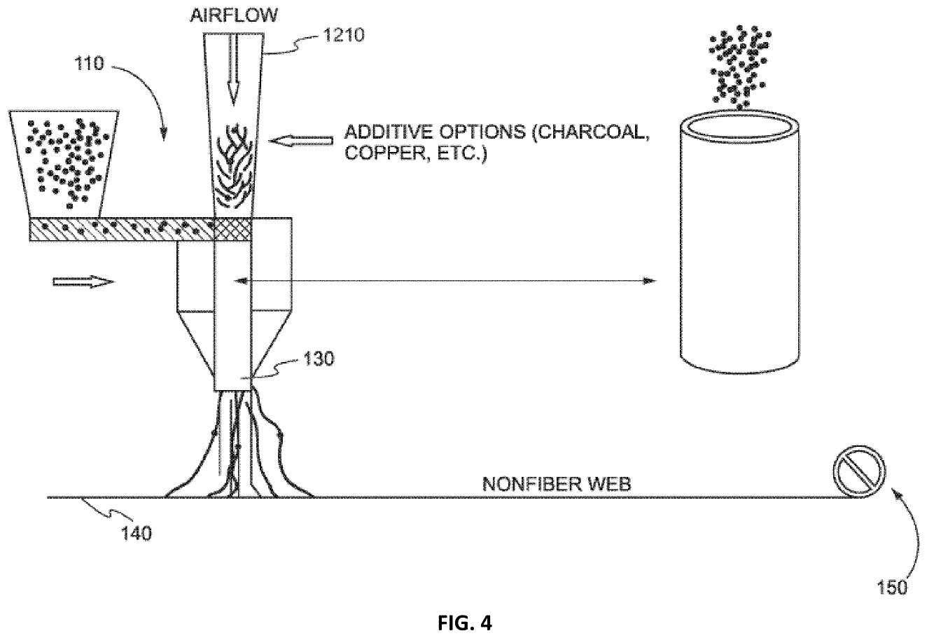

Absorption has been shown to be related to air permeability. As shown in FIG. 3, which plots the absorption coefficient as a function of the air permeability, this relationship holds for Examples 1-6. In particular, Example 3 had the lowest air permeability and shows the highest absorption coefficient. This provides an effective model for determining the absorption coefficient based on measuring the air permeability.

The composites in Table 1 are undyed. Similar constructions as Table 1 were prepared with the face layer being dyed grey and are shown in Table 2. This shows similar air permeability values between the dyed and undyed composites.

TABLE 2

| Example | Scrim | 7 | 8 | 9 | 10 | 11 | 12 |
|---|---|---|---|---|---|---|---|
| Composite | PE | n-PA66 | n-PA66 | n-PA66 | s-PA66 | s-PA66 | m-PA66 |
| | | PE | s-PA66 | m-PA66 | PE | m-PA66 | PE |
| | | | PE | PE | | PE | |
| Total Basis | 63.9 | 149.9 | 253.7 | 224.7 | 182.8 | 251.8 | 176.8 |
| Weight (gsm) | | | | | | | |
| Weighted overall | 11.6 | — | — | — | — | — | — |
| average fiber | | | | | | | |
| diameter | | | | | | | |
| (microns) | | | | | | | |
| Zinc (ppm) | 15 | 166 | 263 | 254 | 155 | 253 | 185 |
| Copper (ppm) | 1 | 13 | 10 | 11 | 6 | 10 | 9 |
| Air Permeability | 563.9 | 80.5 | 29.9 | 22.6 | 182.0 | 51.4 | 32.7 |
| (cfm/sqft) | | | | | | | |

ASTM E1050-98 was used to measure sound absorption coefficients of absorptive materials at normal incidence, that is, 0°. A fiber batting layer was used as a control. Each of the composites in Examples 1-6 were adhered with a thermal bonding web comprising a polyimide to the fiber batting layer. The control has a basis weight of 271.1 gsm, an air permeability of 207 cfm/sq ft., thickness of 13.24 mm and a mean flow pore diameter of 183.6 microns. The sound absorption coefficients of the composites were tested over the range from 0 to 1600 Hz in FIG. 1. Examples 1-6 demonstrated improved sound absorption coefficients over Comparative Example A (control) above 500 Hz. Example 3 had excellent sound absorption coefficients over 1300 Hz. At higher frequencies up to 6500 Hz, the composites of Table 1 and control were tested and the sound absorption coefficients are shown in FIG. 2. Examples 1-6 demonstrated improved sound absorption coefficients over the control above 2000 Hz. The control had poor sound properties. In addition, Example 1 demonstrate superior performance above 4750 Hz. The tube for testing the lower frequencies in FIG. 1 was done using a larger tube with a larger diameter than the higher frequencies in FIG. 2.

While the disclosure has been described in detail, modifications within the spirit and scope of the disclosure will be readily apparent to those of skill in the art. Such modifications are also to be considered as part of the present disclosure. In view of the foregoing discussion, relevant knowledge in the art and references discussed above in connection with the Background, the disclosures of which are all incorporated herein by reference, further description is deemed unnecessary. In addition, it should be understood from the foregoing discussion that aspects of the disclosure and portions of various embodiments may be combined or interchanged either in whole or in part. Furthermore, those of ordinary skill in the art will appreciate that the foregoing description is by way of example only, and is not intended to limit the disclosure. Finally, all patents, publications, and applications referenced herein are incorporated by reference in their entireties.

What is claimed is:

1. A sound absorbing multi-layer composite for a vehicle that reduces sounds along an acoustic path comprising:
a non-foam polymeric layer having a thickness of at least 1 mm; and
a face layer for dissipating sound energy and made of a nonwoven polymer comprising at least 60% of a polyamide containing an aliphatic diamine having 6 or more carbon atoms and an aliphatic diacid having 6 or more carbon atoms, and having at least one surface that is positioned towards to the interior of the vehicle;
wherein the composite is configured to be positioned in the acoustic path so that the sound is at least partially transmitted through the non-foam polymeric layer and at least partially absorbed by the face layer;
wherein the weighted overall average fiber diameter of the composite is from 2 microns to 25 microns.

2. The composite of claim 1, wherein the face layer comprises a first layer and a second layer.

3. The composite of claim 2, wherein the first layer comprises a melt blown nonwoven polymer comprising at least 60% of a polyamide containing an aliphatic diamine having 6 or more carbon atoms and an aliphatic diacid having 6 or more carbon atoms.

4. The composite of claim 2, wherein the first layer comprises a spun bond nonwoven polymer comprising at least 60% of a polyamide containing an aliphatic diamine having 6 or more carbon atoms and an aliphatic diacid having 6 or more carbon atoms.

5. The composite of claim 2, wherein the second layer comprises a melt blown nonwoven polymer comprising at least 60% of a polyamide containing an aliphatic diamine having 6 or more carbon atoms and an aliphatic diacid having 6 or more carbon atoms.

6. The composite of claim 2, wherein the second layer comprises a spun bond nonwoven polymer comprising at least 60% of a polyamide containing an aliphatic diamine having 6 or more carbon atoms and an aliphatic diacid having 6 or more carbon atoms.

7. The composite of claim 2, wherein the nonwoven of the first layer has an average fiber diameter from 200 to 900 nm.

8. The composite of claim 2, wherein the nonwoven of the second layer has an average fiber diameter from 200 to 900 nm.

9. The composite of claim 2, wherein the nonwoven of the first layer has an average fiber diameter that is greater than 1 micron.

10. The composite of claim 2, wherein the nonwoven of the second layer has an average fiber diameter that is greater than 1 micron.

11. The composite of claim 1, wherein the face layer comprises at least one low reflectivity metal.

12. The composite of claim 1, further comprising a yarn for stitching the nonfoam polymeric layer to the face layer.

13. The composite of claim 1, wherein the composite has an air permeability of less than 200 cfm/ft².

14. The composite of claim 1, wherein the face layer comprises a plurality of roped fiber bundles.

15. The composite of claim 1, wherein the face layer has a density of less than 0.2 g/cm³.

16. The composite of claim 1, wherein the non-foam polymeric layer comprises bulking fibers.

17. The composite of claim 1, wherein the non-foam polymeric layer is a non-woven fabric, a woven fabric, a knitted fabric, a film, a paper layer, an adhesive-backed layer, a spun-bonded fabric, a meltblown fabric, or a carded web of staple length fibers.

18. A sound absorbing multi-layer composite for a vehicle that reduces sounds along an acoustic path comprising:
a non-foam polymeric layer having a thickness of at least 1 mm; and
a face layer for dissipating sound energy, wherein the face layer comprises a first and second layer, the first layer being made of a nonwoven polymer comprising at least 60% of a polyamide containing an aliphatic diamine having 6 or more carbon atoms and an aliphatic diacid having 6 or more carbon atoms, having an average fiber diameter that is greater than 1 micron and wherein at least one surface of the second layer is positioned towards the interior of the vehicle;
wherein the composite is configured to be positioned in the acoustic path so that the sound is at least partially transmitted through the non-foam polymeric layer and at least partially absorbed by the face layer;
wherein the weighted overall average fiber diameter of the composite is from 2 microns to 25 microns.

19. The composite of claim 18, wherein the second layer is made of a nonwoven polymer comprising at least 60% of a polyamide containing an aliphatic diamine having 6 or more carbon atoms and an aliphatic diacid having 6 or more carbon atoms, having an average fiber diameter from 200 to 900 nm.

20. A component for a vehicle comprising:
a non-foam polymeric layer having a thickness of at least 1 mm; and
a face layer for dissipating sound energy and made of a nonwoven polymer comprising at least 60% of a polyamide containing an aliphatic diamine having 6 or more carbon atoms and an aliphatic diacid having 6 or more carbon atoms, and having at least one surface that is positioned towards the interior of the vehicle,
wherein the weighted overall average fiber diameter of the composite is from 2 microns to 25 microns; and
wherein the component comprises a headliner, trim, panel, or board.
